(19) United States
(12) Patent Application Publication
(10) Pub. No.: US 2013/0203533 A1
(43) Pub. Date: Aug. 8, 2013

(54) Compact Torque Converter

(71) Applicant: Charles Yvon Lafontaine, Berthoud, CO (US)

(72) Inventor: Charles Yvon Lafontaine, Berthoud, CO (US)

(21) Appl. No.: 13/743,160

(22) Filed: Jan. 16, 2013

Related U.S. Application Data
(60) Provisional application No. 61/588,982, filed on Jan. 20, 2012.

(51) Int. Cl. F16H 7/02; B23P 17/00

(52) U.S. Cl. CPC F16H 7/02; B23P 17/00
USPC 474/88; 29/401.1

(57) ABSTRACT

An assembly provides an indirect, rather than direct, drive from a power source to a rotating machine powered by the power source. The assembly includes one or more first pulleys that are connected to the drive source by one or more first belts, and one or more second pulleys that are connected to the rotating machine. Power is transmitted by the power source to the one or more first pulleys, to the one or more second pulleys by a shaft, and to the rotating machine by one or more second belts connecting the one or more second pulleys to a pulley of the rotating machine. The assembly provides for greater speed of and/or torque transmission to the rotating machine with fewer associated problems than if the rotating machine were connected directly to the power source.

### BACKGROUND OF THE INVENTION

The present invention relates to the enhancement in output of rotating machines such as alternators, generators, propellers, and pumps typically driven by a power source such as electric motors, reciprocating engines, micro-hydro turbines, or other power sources that produce rotary output. Typically the rotating machine is linked to the power source through belts or chains via pulleys mounted onto both the motor output shaft and rotating machine input shaft. Improvements in rotating machine output would also be realized in systems where the power source (drive motor) output shaft is coupled directly (direct drive) to the input shaft of the present invention.

The physical characteristics, geometries, and components of rotating machines are well known. For example, the major components of typical automotive alternators comprise a rotor, stator, slip rings (non brushless) and a rectifier sub-assembly to produce and distribute the electrical power. The alternator also comprises structural components such as front and rear end bells that house the bearings which allow the rotor to spin centered within the stator. Typically, the end bells are held in place with nuts and bolts arrayed around the periphery of the stator which is sandwiched by the end bells. Structural features of the end bells cooperate to maintain and align external and internal components.

Electric motors designs are similar in design to alternators, with stators, rotors, bearings, and housing components that align and center the rotor within the stator. U.S. Pat. No. 7,122,923 to Lafontaine et al., which is incorporated herein by reference, describes one method of maintaining, aligning, and centering components of a permanent magnet machine through the use of tie rods, outer cylinders, endplates, bearings, and shafts.

Generally speaking, rotating machines can be divided into two types of components: (1) function components, and (2) structural components that hold and align components to function properly. As will be explained below, the CTC portion of a CTCRM preferably has shafts, bearings, circlips and other hardware that cooperate to transmit power. That hardware along with nuts and bolts that sandwich the stator and help to align and positionally maintain the components of the CTC-RM so it can function properly. That hardware alone may not be enough to align properly the components and that other structures such as locating collars and pins required to maintain rotating machine components in alignment. Although these ancillary components are known, they are extraneous to the functioning of the CTC-RM. Therefore, these features will not be described here.

In automotive applications the ability to modify (increase or decrease) the RPM of a rotating machine, such as an alternator, pump, or compressor over part or preferably all of the entire operational RPM range of the engine would be of great benefit. For example, alternator output is directly related to the speed of the alternator so that any increase in RPM yields an increase in alternator output. Typically, the vehicle engine is equipped with a crank pulley mounted to the crank shaft, and through the serpentine belt of the Front End Accessory Drive (FEAD), the belt transmits power to the accessories (rotating machines). An accessory such as an alternator (or any other rotating machine driven by the engine) can have increased RPM across the entire RPM range of the engine by either: (1) decreasing the diameter of the rotating machine pulley, or (2) increasing the diameter of the crank pulley. In either case, the crank-to-rotating machine pulley ratio is increased, which increases the speed of the rotating machine.

Unfortunately, decreasing pulley diameter of the rotating machine introduces the possibility of belt slippage since both belt wrap and belt contact arc length are important factors in power transmission.

Increasing the diameter of the engine crank pulley is also problematic. Engine crank pulleys not only drive rotating machines through the FEAD, but are also balanced with engine components to assure smooth operation of the engine. Any modification to the crank pulley would likely require redesigning engine components to ensure engine operation is not compromised. It would therefore be desirable to have the ability to increase or decrease the RPM of rotating machines without changing pulley ratios

Further, in high-speed engine applications such as in racing cars, the elevated engine RPM (as high as 16,000 RPM) would be detrimental to certain components. For example, certain water pumps have an upper RPM limit that if exceeded, could destroy the pump. In those instances it would be beneficial to decrease the RPM of the accessory across part or preferably all of the entire RPM range of the engine. The pump (or any other rotating machine) can yield a net decrease in RPM across the entire RPM range of the engine by either increasing the diameter of the rotating machine pulley or decreasing the diameter of the crank pulley. In either case, the crankto-rotating-machine pulley ratio is decreased, which decreases the speed of the rotating machine. But, increasing pulley diameter of the rotating machine introduces stresses at the shaft and pulley due to the increased rotational inertia of the larger pulley that may prove unacceptable. Another problem is that decreasing the diameter of the crank pulley can produce an imbalance in the pulley/crank system. It would therefore be desirable to have the ability to decrease the RPM of the rotating machine without changing pulley ratios.

Modifying rotating machine RPM in automotive applications is problematic, but equally difficult is modifying components to increase the amount of power transmitted from the engine to rotating machines (or accessories). For example, high output alternators such as permanent magnet alternators are well known and require greater amounts of input power over conventional alternators to maximize their output capability. This is also true if an accessory such as an air compressor is replaced with a higher CFM compressor: more power is required to optimize output.

One method of increasing the amount of power that can be transmitted to the rotating machine is to increase the width of the serpentine belt that drives the rotating machine. For example a diesel engine may be equipped with an 8 groove, K profile, polyv belt that cannot deliver adequate power without belt slippage. The solution is to change the crank and accessory pulleys to accept a 10 or 12 groove belt. This may not be possible due to the increased cost, the extra engineering required to assure proper operation, or the space required to accommodate increased belt width may not be available.

A second method is to increase the diameter of the accessory's pulley, which increases contact distance (or “contact length”) between the belt and pulley. Contact length is an important factor in the amount of power that can be transmitted to the pulley. As mentioned above, this approach would present structural redesign issues in high speed applications but in low speed applications, such as large diesel engines those issues are not relevant. Unfortunately, this approach results in a decrease in crank-toaccessory pulley ratio, which results in a decrease in the RPM of the accessory. As mentioned previously, alternator output is directly proportional to its speed. This is true of high output alternators as well as conventional alternators, so even though power transmission capability to the rotating machine is improved, the decrease in RPM may result in an unacceptable decrease in alternator output.

Another method of increasing the amount of power transmitted to an accessory is to increase belt wrap around the accessory pulley. Belt wrap and its ability to transmit power is a complex function of different factors and is not simply a linear relationship; rather, it increases exponentially as belt wrap angle increases so that even small increases in belt wrap can yield significant increases in power transmission capability. This is typically accomplished by mounting idler pulleys in close proximity to the accessory drive pulley in a location that increases belt wrap around the accessory pulley. Unfortunately, finding space or surfaces to mount extra idler pulleys in engine compartments can be problematic. It would therefore be desirable to increase the amount of belt wrap by adding additional idler pulleys without using elaborate brackets or having to locate existing engine features to mount those additional idler pulleys.

Wind power is of special interest when considering issues of global warming as a result of burning fossil fuels and the rising costs of commercially-produced electrical power. Many wind turbines rotate at speeds that are not favorable for power generation. As mentioned above, the output an alternator or generator can produce is proportional to its speed. This is not particularly important with large wind turbines, which can use elaborate and heavy gear transmissions to multiply the speed of the blades of the generator to increase efficiency and output. This is not true for 50 kW and smaller wind turbines where space and weight are at a premium. Such turbines are used to generate power in homes, farms, ranch settings, or for small boats. Therefore, it would be desirable to have a method of multiplying the speed of a generator powered by a wind turbine without using heavy and elaborate transmissions.

Hydro power production is similar with respect to wind power in that it can offer a means of producing electricity without the negative impact of burning fossil fuels. Hydro power production is well known with, for example, Kaplan (Bulb) and Francis turbine designs, which have been in use now for many years. Each of these applications couples the generator input shaft directly to the output shaft of the turbine. In the case of Kaplan applications, the turbine shaft rotates at relatively low speeds (typically 80-400 RPM) with Francis turbine rotating at slightly higher speeds (80-1000 RPM). In both applications, the low shaft RPM of Kaplan and Francis generators (>50 kW), is not as significant a limiter of output as would be encountered with small generators because the larger diameter of the rotor can accommodate more poles. The increased number of poles effectively increases output capability, essentially offsetting the deleterious effects of low RPM. The space to accommodate more poles is not available in smaller generators, therefore it would be desirable to increase generator RPM in small Kaplan and Francis generator applications to maximize output with as little modification to the infrastructure as possible.

Another class of generators are micro turbines that produce significantly smaller amounts of power (1.5 kW or less) where elaborate structures and earth works are not possible resulting in little or no head (low static water pressure). In these instances turbine speed is limited to the speed of the stream as it passes by the turbine. That speed is generally not conducive for power production, so it would be beneficial to have a method of increasing generator speed under those operating conditions.

Small aircraft applications such as Unmanned Arial Vehicles (UAV) and Remote Control (RC) aircraft (48-inch wingspan and smaller) can benefit from reduced engine RPM while maintaining propeller speed For example, airborne diesel engines are well known (e.g., Junkers Jumo 204, 205, 206, 207, and 208 engines deployed on civil and military aircraft beginning in 1932). In UAV applications, a small diesel engine can offer many of the advantages of its automotive counterparts: durability, fuel economy, reliability, and high power at low RPM. The relatively low RPM of a UAV diesel engine reduces output capability of an alternator as well therefore; the ability to increase the speed of a UAV alternator relative to the speed of its diesel engine power plant would be of value.

### SUMMARY OF THE INVENTION

The present invention, a compact torque converter (CTC), enhances and improves rotating machine functionality with little or no modification to the rotating machine itself or to surrounding structural components. Improvement can be in form of either an increased or decreased RPM of the rotating machine or increased power delivered to the rotating machine. In one category, the CTC is designed as a separate mechanical system linked and mounted to the rotating machine, such as through belts, pulleys and fasteners. In the second category, the CTC is integrated into the rotating machine to form a single assembly while still enhancing rotating machine functionality.

### BRIEF DESCRIPTION OF THE DRAWINGS

The present invention will be described in conjunction with the following figures of the appended drawing.

FIG. 1A is a front view of a first embodiment in accordance with the present invention, which includes a cut-away view.

FIG. 1B is a sectional view (taken along line A-A in FIG. 1A) of the first embodiment of the CTC of FIG. 1.

FIG. 1C is a sectional view (taken along line B-B in FIG. 1A) of the first embodiment of the CTC of FIG. 1.

FIG. 1D is a rear view of the first embodiment of the CTC of FIG. 1.

FIG. 2A is a simplified front and side view showing a typical, conventional alternator application.

FIG. 2B is a schematic of pulley ratios of the typical application shown in FIG. 2A.

FIG. 2C is a schematic showing pulley ratios of an application, wherein the pulley ratios have been modified to increase the RPM of the rotating machine without the benefit of using a CTC.

FIG. 2D is a schematic showing pulley ratios of an alternate application, wherein the pulley ratios have been modified to increase the RPM of the rotating machine without the benefit of using a CTC.

FIG. 2E is a schematic showing pulley ratios of an application, wherein the pulley ratios have been modified to increase power to a rotating machine without the benefit of using a CTC.

FIG. 2F is a front, side and rear view of the first embodiment of the CTC shown in FIG. 1.

FIG. 2G is a schematic showing pulley ratios of the first embodiment of a CTC shown in FIG. 1, wherein increased RPM of the rotating machine is desirable.

FIG. 2H is a schematic showing pulley ratios of the first embodiment of a CTC shown in FIG. 1, wherein increased power to the rotating machine is desirable

FIG. 3A is a front view of a second embodiment in accordance with the present invention, which includes cut-away views.

FIG. 3B is a front view of the second embodiment of the CTC of FIG. 3A with pulleys removed for clarity.

FIG. 3C is a sectional view (taken along line C-C in FIG. 3A) of the second embodiment of the CTC.

FIG. 3D is a sectional view (taken along line D-D in FIG. 3A) of the second embodiment of the CTC.

FIG. 3E is a rear view of the second embodiment of the CTC of FIG. 3A.

FIG. 4A is a front view of a third embodiment in accordance with the present invention, including cut-away views.

FIG. 4B is a front view of the third embodiment of the CTC of FIG. 4A with pulleys removed for clarity.

FIG. 4C is a sectional view (taken along line E-E in FIG. 4A) of the third embodiment of the CTC.

FIG. 4D is a sectional view (taken along line F-F in FIG. 4A) of the third embodiment of the CTC.

FIG. 4E is a rear view of the third embodiment of the CTC.

FIG. 5A is a front view of a fourth embodiment in accordance with the present invention with cut-away views.

FIG. 5B is a front view of the fourth embodiment of the CTC of FIG. 5A with pulleys removed for clarity.

FIG. 5C is a sectional view (taken along line G-G in FIG. 5A) of the fourth embodiment of the CTC.

FIG. 5D is a view (bounded by detail line H in FIG. 5C) of the fourth embodiment of the CTC.

FIG. 5E is a rear view of the fourth embodiment of the CTC.

FIG. 6A is a front view of a fifth embodiment in accordance with the present invention with cut-away views.

FIG. 6B is a front view of the fifth embodiment of the CTC of FIG. 6A with pulleys removed for clarity.

FIG. 6C is a side view of the fifth embodiment of the CTC.

FIG. 6D is a sectional view (taken along line J-J in FIG. 6A) of the fifth embodiment of the CTC.

FIG. 6E is a view (bounded by detail line K in FIG. 6C) of the fifth embodiment of the CTC.

FIG. 6F is a rear view of the fifth embodiment of the CTC.

FIG. 7A is a front view of a sixth embodiment in accordance with the present invention with cut-away views.

FIG. 7B is a front view of the sixth embodiment of the CTC of FIG. 7A with pulleys removed for clarity

FIG. 7C is a side view of the sixth embodiment of the CTC.

FIG. 7D is a sectional view (taken along line L-L in FIG. 6A) of the sixth embodiment of the CTC.

FIG. 7E is a view (bounded by detail line M in FIG. 7C) of the sixth embodiment of the CTC.

FIG. 7F is a rear view of the sixth embodiment of the CTC.

FIG. 8A is a front view of a seventh embodiment in accordance with the present invention with cut-away views.

FIG. 8B is a front view of the seventh embodiment of the CTC of FIG. 8A with pulleys removed for clarity

FIG. 8C is a sectional view (taken along line N-N in FIG. 8A) of the seventh embodiment of the CTC.

FIG. 8D is a sectional view (taken along line P-P in FIG. 8A) of the seventh embodiment of the CTC.

FIG. 8E is a sectional view (taken along line Q-Q in FIG. 8A) of the seventh embodiment of the CTC.

FIG. 8F is a rear view of the seventh embodiment of the CTC.

### DETAILED DESCRIPTION OF PREFERRED EMBODIMENTS

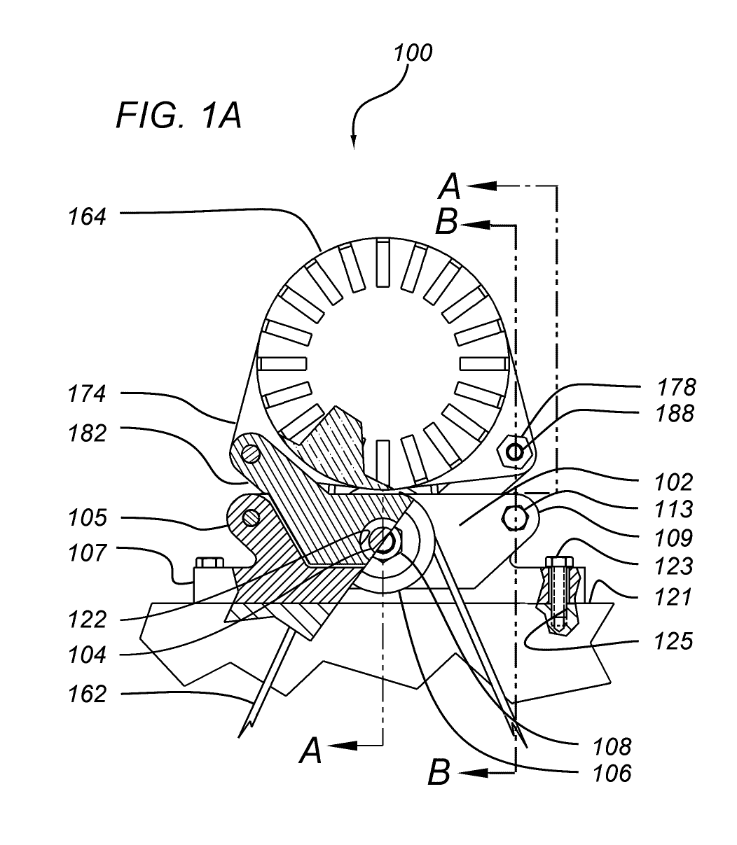

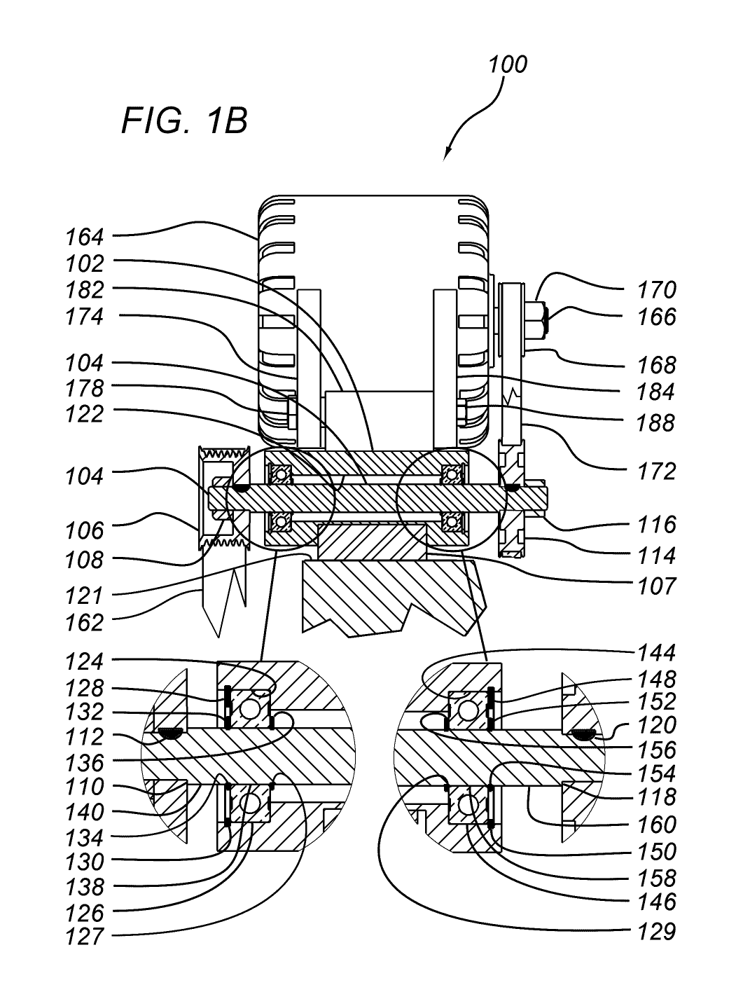

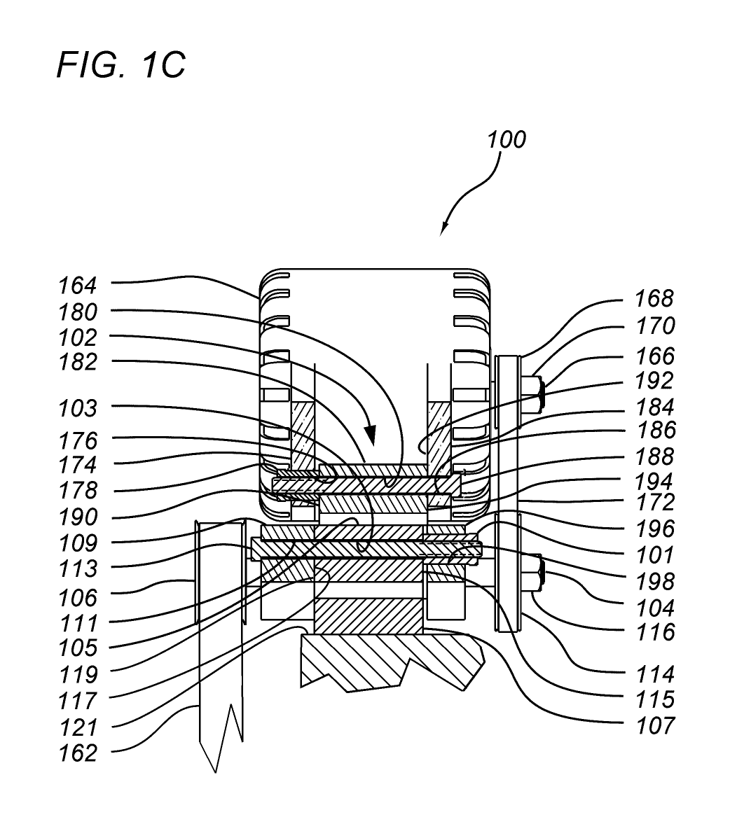

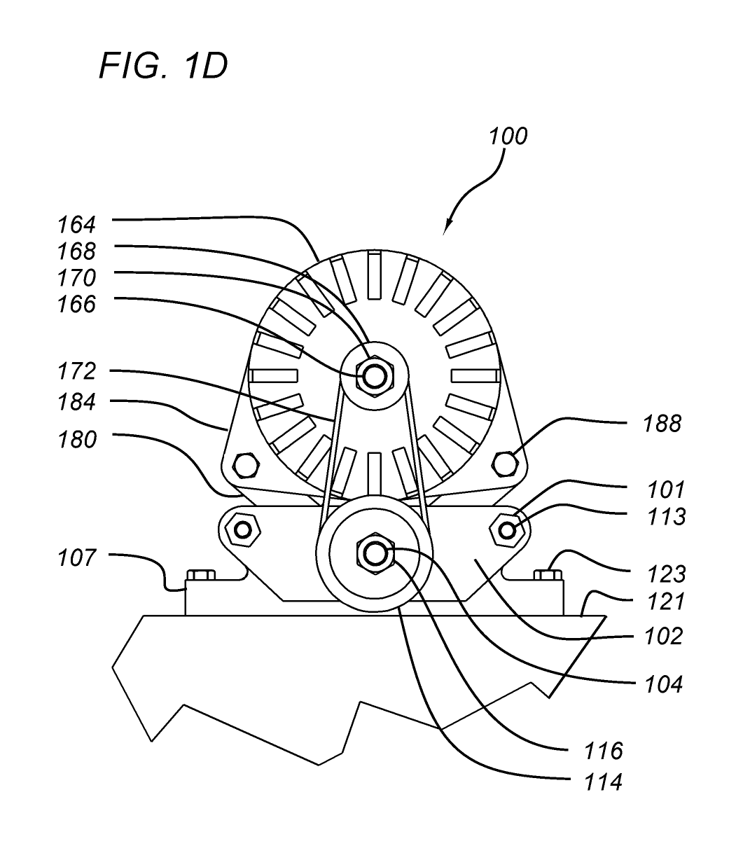

Referring now to FIGS. 1A-D, which are collectively referred to as FIGS. 1, a first embodiment of a CTC assembly 100 comprises: a single shaft CTC body 102, a shaft 104 and a pulley 106. Pulley 106 is fixed to shaft 104 by nut 108 to press pulley 106 onto a shaft surface 110. Pulley 106 is also fixed to shaft 104 by a key 112. In certain applications the friction developed between pulley 106 and shaft surface 110 by nut 108 is sufficient to resist the torque developed by pulley 106 to eliminate the need for key 112. Press fitting or gluing pulley 106 onto shaft 104 can also be employed to fix pulley 106 adequately onto shaft 104.

CTC 102 body is preferably die-cast or sand-cast aluminum, such as type A356, but other suitable materials such as magnesium, steel, or engineered plastic such as polyamide-imide can be utilized. Alternatively, CTC 102 body can be machined from a solid billet of aluminum such as type 6061-T651 or other suitable material such as magnesium, steel, engineered plastic, or other appropriate material.

Shaft 104 is preferably stress-proof steel such as type SAE 1144 or similar steel or other material designed to withstand the stresses and loads that are encountered in high stress rotating shaft applications such as those present in alternators and pumps. But, shaft 104 can also be fabricated from other materials as application requirements allow. Pulleys 106 and 114 preferably are machined from cast steel or other appropriate materials.

CTC body 102 contains through bore 122. Bearing bore 124 is preferably bored to a high tolerance (e.g., +0.0001 to +0.0004 inches over nominal diameter) to accept a bearing 126 and is concentric with through bore 122. Bearing 126 is preferably maintained in bearing bore 124 by circlip 128 seated in groove 130. Bearing 126 is located on shaft 104 between circlip 132 seated in groove 134 and circlip 136 seated in groove 127. Surface 138 on shaft 104 between groove 134 and groove 127 is preferably machined to a high tolerance (e.g., +0.0000 to −0.0003) to accept bearing 126 in assembly 100.

Shaft surface 140 is machined with sufficient clearance to allow bearing 126 to slip past surface 140 during assembly and seat on surface 138. Bearing bore 144 is preferably bored to a high tolerance (e.g., +0.0001 to +0.0004 inches over nominal diameter) to accept bearing 146 and is concentric with through bore 122. Bearing 146 is maintained in bearing bore 144 by circlip 148 seated in groove 150. Bearing 146 is axially located on shaft 104 between circlip 152 seated in groove 154 and circlip 156 seated in groove 129. Surface 158 on shaft 104 between groove 154 and groove 129 is preferably machined to a high tolerance (e.g., +0.0000 to −0.0003) to accept bearing 146 in assembly. Shaft surface 160 is machined with sufficient clearance to allow bearing 146 to slip past surface 160 during assembly and seat on surface 158.

Bearing bores 124 and 144, and bearings 126 and 146, cooperate to align shaft 104 with through bore 122. Bearing 126, circlips 128 and 132 and 136, bearing 146, circlips 148, 152 and 156, cooperate to fix shaft 104 in CTC assembly 100. Nut 108 and surface 110 fix pulley 106 on shaft 104. Key 112 also fixes pulley 106 on shaft 104. Nut 116 and surface 118 fix pulley 114 on shaft 104. Key 120 also fixes pulley 114 on shaft 104.

Power is transmitted to pulley 106 from a pulley mounted to a power source (not shown) through belt 162. Belt 162 in this embodiment is preferably a poly-v belt but can be a roller chain, v-belt, rope, or any other device suitable for transmitting power to pulley 106. Pulley 106 transmits power from belt 162 to rotating machine 164 through shaft 104, pulley 114, and belt 172 then to pulley 168 of rotating machine 164. Pulley 168 is fixed to shaft 166 by nut 170 and imparts rotation to shaft 166 which in turn rotates internal components (not shown) of rotating machine 164, which produces an output. The output of rotating machine 164 can be electrical power, gas compression, fluid flow or any output generated by a rotating machine. Belt 162 is preferably a poly-v belt but can be a roller chain, v-belt, rope, or any other device suitable for transmitting power to pulley 106.

For example, in automotive applications the power source is typically an internal combustion engine and the power is transmitted from a crank pulley (not shown), which is fixed to the crankshaft (not shown) of the engine (not shown) to pulley 106.

In industrial applications, the power source can be an electric motor, hydraulic motor, pneumatic motor, any suitable power source. The power source is mounted with a pulley on the main shaft to transmit power. Power take offs (PTOs) or other types of engine transmission auxiliary drive shafts can be equipped with pulleys to drive the rotating machine. Belt 172 is preferably a synchronous or ‘cogged timing’ belt but can be equally effective using a roller chain, v-belt, poly-v belt, rope, or any other device suitable for transmitting power from pulley 114 to pulley 168. Synchronous belts are well known for their capability to transmit large amounts of power relative to their cross sectional areas and ability to resist slippage.

Mounting ears 174 of rotating machine 164 have holes 176 that are sized to accept threaded slip bushings 178 and align with through holes 180 of mounting ears 182 of CTC body 102. Mounting ears 184 of rotating machine 164 have clearance holes 186 that accept bolts 188 and align with through holes 180 of mounting ears 182 of CTC body 102. Bolts 188 are inserted through holes 180 and 186 and thread into slip bushing 178. When tightened, bolts 188 draw threaded slip bushings 178 against surface 190 of mounting ears 182 of CTC body 102 which in turn draws surface 192 of mounting ear 184 of rotating machine 164 against surface 194 of mounting ears 180 of CTC body 102. Holes 176, 180, and 186 in cooperation with bolts 188 and threaded slip bushings 178 fix rotating machine 164 to CTC body 102.

Mounting ears 196 of CTC body 102 have holes 198 that are sized to accept slip bushings 101 and align with through holes 103 in mounting ears 105 of bracket 107. Mounting ears 109 of CTC body 102 have holes 111 that are sized to accept bolts 113 and align with through holes 103 in mounting ears 105 of bracket 107. Bolts 113 are inserted through holes 103 and 111 and thread into slip bushings 101. When tightened, bolts 113 draw threaded slip bushings 101 against surface 115 of CTC body 102 mounting ears 196 which in turn draws surface 117 of mounting ears 109 of CTC body 102 against surface 119 of mounting ears 105 of bracket 107. Holes 198, 103, and 111, in cooperation with bolts 113 and slip bushings 101, fix CTC body 102 to bracket 107. Bracket 107 is fixed to mounting surface 121 with bolts 123 that align with tap holes 125 in mounting surface 121.

In automotive applications, mounting surface 121 could be the surface of the combustion engine itself. This is typically the case in automotive applications where the rotating machine, in this example an alternator, would use a bracket (107) to mount the alternator (rotating machine 164) to the engine. In applications where bracket 107 is relatively simple, the CTC can be designed to mount directly to surface 121 thereby eliminating the need for bracket 107. However, many automobile applications have complex bracket assemblies that mount many accessories. In these instances replacing the complex bracket becomes cost prohibitive and the ability to mount the CTC to the existing bracket is advantageous. In industrial applications, the mounting surface can be the floor, a support structure, or other piece of industrial equipment associated with the rotating machine.

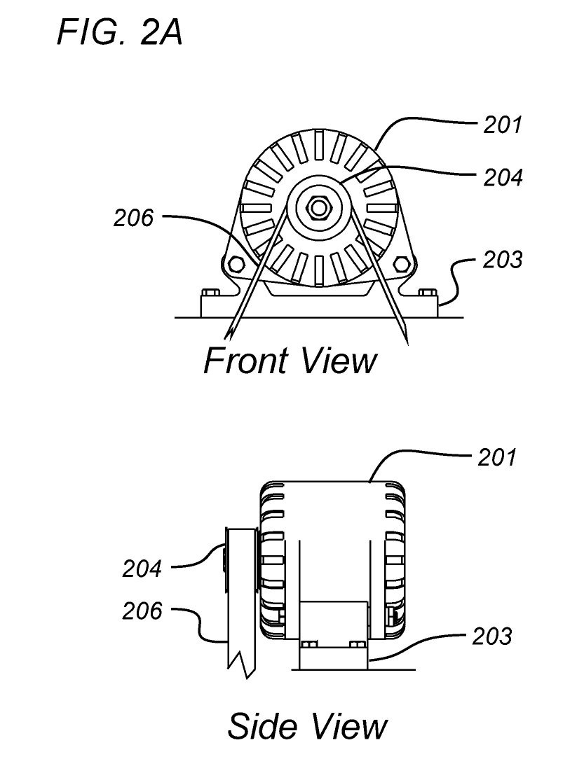

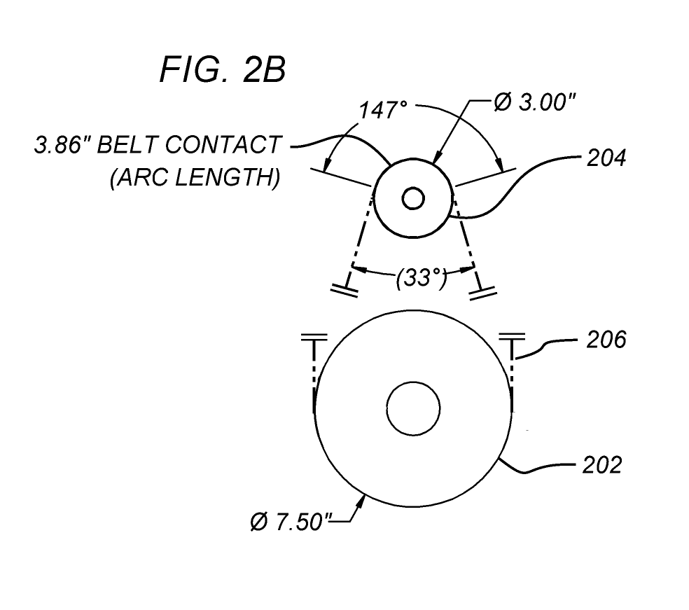

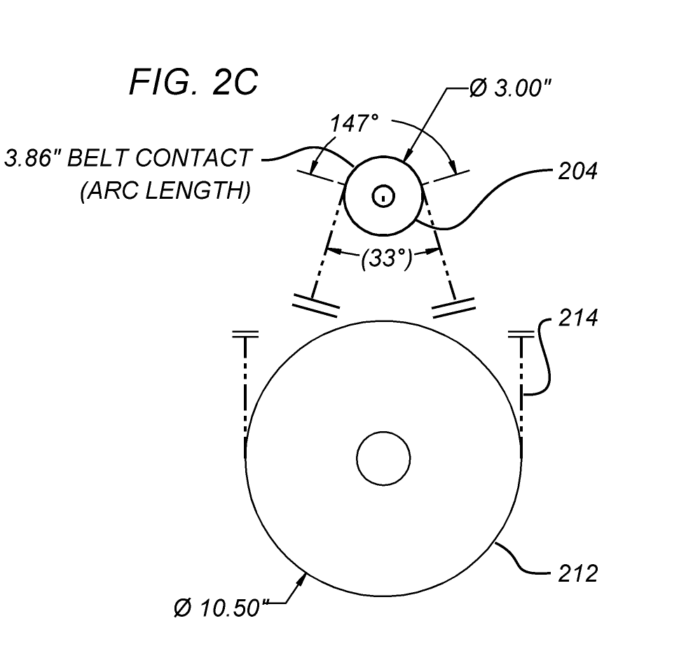

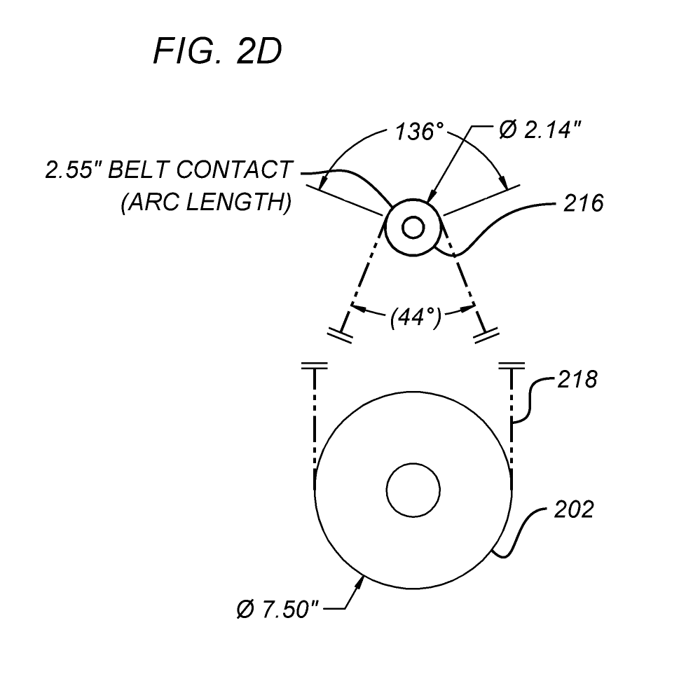

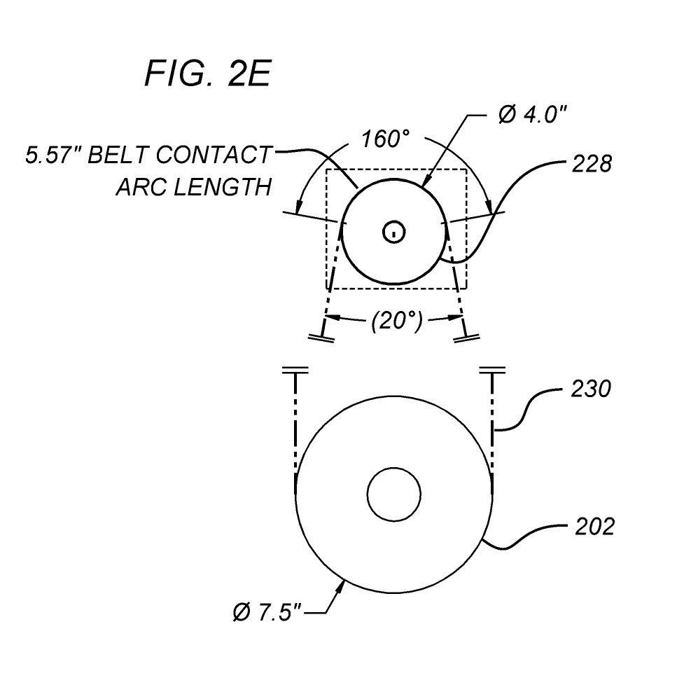

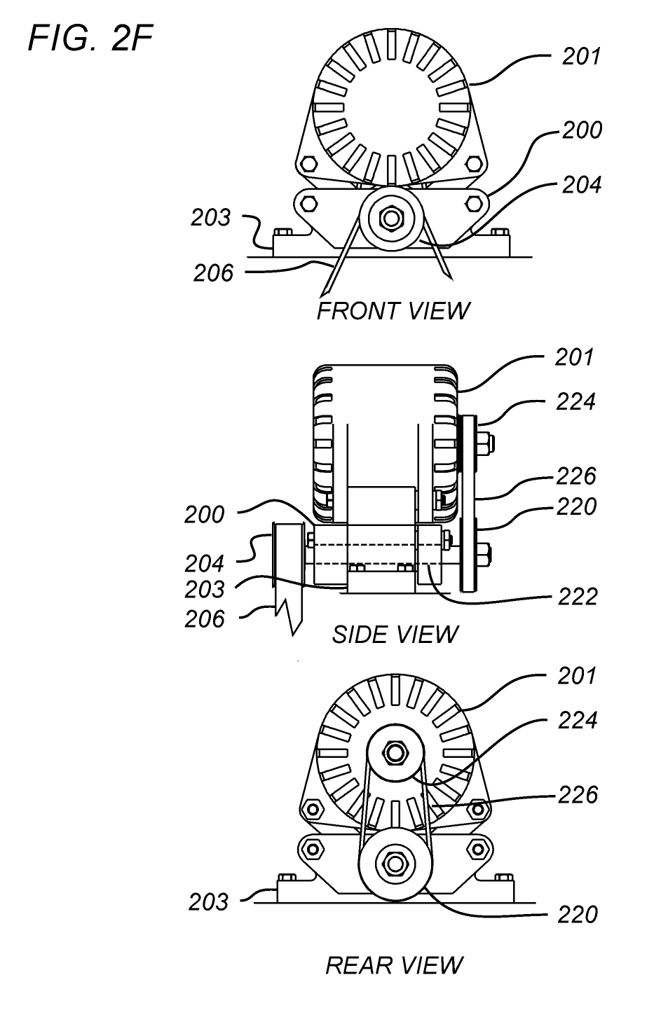

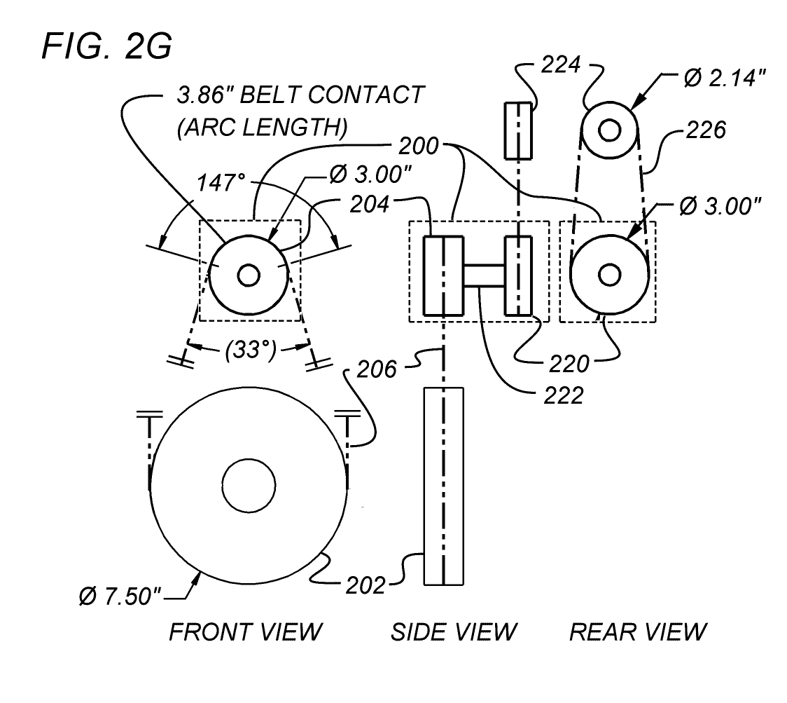

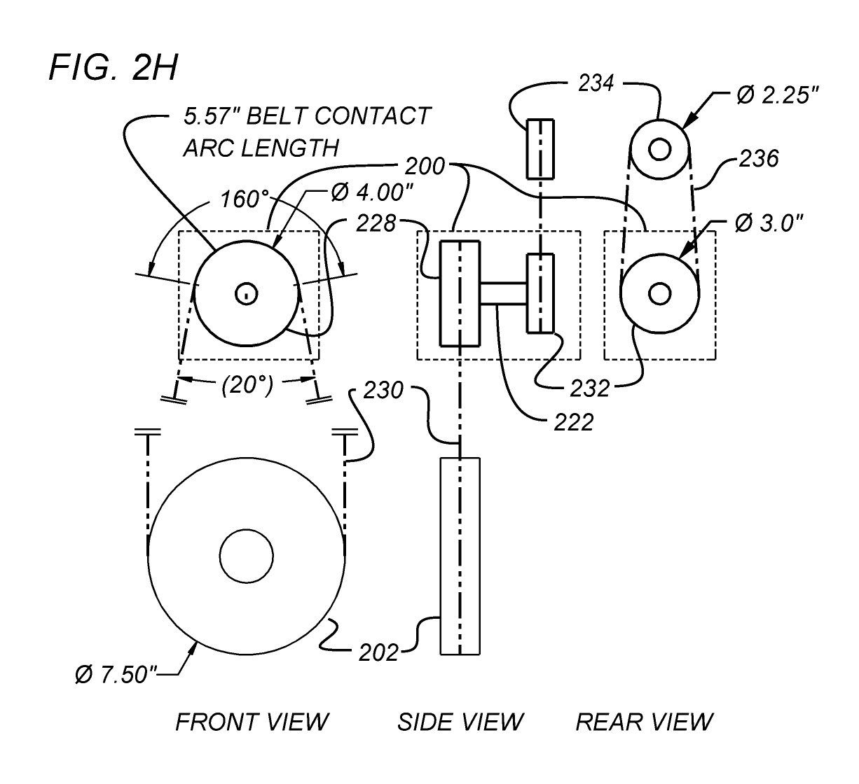

Referring now to FIGS. 2A-2H collectively referred to as FIG. 2, for rotating machine applications such as alternators, pumps, and compressors, it would be advantageous to have the capability of increasing or decreasing the RPM of the rotating machine with as little alteration to the existing equipment as possible. Equally beneficial would be the ability to increase the amount of power (torque×RPM) delivered to the rotating machine, again with as little alteration to the existing equipment as possible.

In this embodiment, the rotating machine is an alternator wherein output is directly proportional to the RPM of the alternator, i.e., the higher the RPM the higher the output. Utilizing a large diesel engine for the purpose of this example, a typical alternator output at engine idle (700 RPM) may be expected to be approximately 40 amps and approximately 200 amps at the highest suggested RPM (2400 RPM redline) of the diesel engine. By simply using the original alternator and increasing its RPM across the entire RPM range (700 to 2400), an increase in output would be realized. There are of course other considerations such as diode and bearing capability to be accounted for but in general, an increase in rotating machine RPM would yield a net increase in output. This is generally true for pumps, compressors, and other rotating machines as well.

Belt wrap and belt contact (arc length) depicted in FIGS. 2B, 2C and 2D are not meant to describe an absolute or fixed set of variables, but rather are used as a means to compare relative belt wrap and belt contact and the effect modification has on these variables. Actual application conditions and equipment geometries will vary from application to application.

FIG. 2A depicts a typical automotive configuration (front and side view), wherein the rotating machine 201 is mounted to a bracket 203. Pulley 204 of the rotating machine is driven by serpentine belt 206 wrapped over pulley 204 driven in turn by crank pulley 202 (not shown in FIG. 2A).

FIG. 2B depicts pulley ratios of the device of FIG. 2A. Drive (crank) pulley 202 of the diesel engine (not shown) has a diameter of 7.50″ in this embodiment and pulley 204 of the alternator (i.e., the rotating machine, not shown) has a diameter of 3.00″. Belt 206 transmits power from drive pulley 202 to rotating machine pulley 204. The pulley ratio of drive pulley 202 to rotating machine pulley 204 is 7.50″:3.00″ or 2.5:1. At a ratio of 2.5:1, pulley 204 rotates at 1750 RPM when drive pulley 202 rotates at 700 RPM and 6000 RPM when drive pulley 202 is rotating at 2400 RPM. The belt wrap angle in this configuration is 147° with a belt contact arc length of 3.86″.

To increase the RPM of the alternator without the benefit of a CTC, one of two options are available. In the first option, crank pulley diameter is increased; in the second, the diameter of rotating machine pulley is decreased. Each of these methods will increase the rotating machine RPM by increasing pulley ratios but also will introduce problems, as discussed previously.

FIGS. 2C and 2D depict two options to increase alternator RPM without the benefit of a CTC.

In FIG. 2C, the first method of increasing RPM of the rotating machine is shown. The diameter of the drive (crank) pulley 212 is increased to 10.5″ while leaving the rotating machine (alternator) pulley 204 unchanged at 3.00″. Belt 214 would be longer than belt 206 to accommodate the increased diameter of pulley 212. As can be seen, the resulting ratio increases to 10.50″:3.00″ or 3.5:1 over the 2.5:1 depicted in FIG. 2B. The belt wrap angle of 147° and belt contact arc length of 3.86″ remain unchanged.

This approach would increase the RPM of the rotating machine by increasing the pulley ratio to 3.5:1. At a ratio of 3.5:1, the rotating machine pulley 204 rotates at 2450 RPM when drive pulley 212 rotates at 700 RPM and 8400 RPM when drive pulley rotates at 2400 RPM. Although an increase in rotating machine RPM is achieved, in most instances this configuration would prove impractical since modification of the drive pulley could involve a major design changes to the entire system. For example, the crank pulley of a diesel engine is balanced to cooperate with the firing sequence and rotational inertia of the engine; thus, any change to the crank pulley would require considerable engineering changes to assure proper operation of the diesel engine. The increased space required to accommodate the larger crank pulley would also prove problematic.

In FIG. 2D the second method of increasing rotating machine RPM is shown. In this embodiment, the diameter of rotating machine pulley 216 is decreased to 2.14″ while leaving the drive pulley 202 unchanged at 7.50″. Belt 218 will be shorter than belt 206 to accommodate the decrease in diameter of pulley 216. As can be seen, the resulting ratio increases to 7.50″:2.14″ or 3.5:1 over the 2.5:1 depicted in FIG. 2B. Rotating machine pulley 216 rotates at 2450 RPM when drive pulley 202 rotates at 700 RPM and 8400 RPM when drive pulley 202 rotates at 2400 RPM. The belt wrap angle decreases from 147° to 136° and belt contact arc length decreases from 3.86″ to 2.55″. This approach would increase the RPM of the rotating machine but could introduce belt slippage since the amount of power that can be transmitted by belt 218 to pulley 216 is a function of belt wrap angle and the length of belt contact with the pulley. Both belt wrap and contact length are decreased using this approach. There are of course other factors that impact the amount of power that can be transmitted by the belt, but the belt wrap angle and the length of belt contact (arc length) with the pulley have the greatest impact on a belt's ability to transmit power. Belt contact length could be more accurately described as belt contact area, in which both length of contact and belt width (number of groves in a poly-v belt for example) are considered.

One method of increasing power to the rotating machine is to increase the width of the belt used in transmitting power which effectively increases belt contact area. For example, changing the original 4 groove poly-v belt for 6 or 8 groove poly-v belts would increase power capability by increasing the total belt surface area in contact with the pulley, but can introduce redesign challenges. For any given automotive application, belt type is typically predetermined (e.g., a 4-groove poly-v belt) by the manufacturer. Once a belt width has been selected, the remaining available space is occupied by other engine components. This means that increasing belt width may not be a viable option for many applications.

A second method of increasing power capability is to increase belt wrap angle through the use of idler pulleys. The amount of power that can be transmitted as it relates to belt wrap is not a simple linear relationship but is more akin to an exponential relationship Therefore, increasing belt wrap can be beneficial for increasing the torque and power through the belt, but is not practical in all applications since the available space to locate idler pulleys is limited.

A last method that will be discussed to increase power capability without using a CTC is to increase the diameter of the rotating machine pulley, which is depicted in FIG. 2E. Increasing pulley diameter increases belt contact arc length and to a lesser extent increases belt wrap angle which improves power transmission capability.

In FIG. 2E the diameter of rotating machine (alternator) pulley 228 is increased to 4.00″ while leaving the drive pulley 202 unchanged at 7.50″. Belt 230 will be longer than belt 206 to accommodate the increase in diameter of pulley 228. The pulley ratio in FIG. 2E decreases from 2.5:1 depicted in FIG. 2A to 7.50″:4.00″ or 1.88:1 and at that ratio, pulley 228 rotates at 1312 RPM when drive pulley 202 rotates at 700 RPM and 4500 RPM when drive pulley 202 rotates at 2400 RPM. Although power capability is increased, the resulting decrease in RPM may not produce acceptable output (e.g., in the case when the rotating machine is an alternator) due to the decrease in overall RPM of the rotating machine.

The use of CTCs can provide both increased RPM and ability to manage concomitant increased power management requirements to rotating machines. FIG. 2F depicts a typical CTC configuration where CTC 200 is mounted to bracket 203 with rotating machine 201 mounted to CTC 200. Pulley 204 is fixed to CTC shaft 222 and is driven by serpentine belt 206 wrapped over pulley 204 which in turn is driven by engine crank pulley 202 (not shown). As described in the first preferred embodiment of the present invention, pulley 220 is also fixed to shaft 222 and rotates in unison with pulley 204. Pulley 224 of rotating machine 201 is linked to pulley 220 with belt 226. Power is transmitted to pulley 204, which, being fixed to shaft 222, transmits power via shaft 222 to pulley 220 which transmits power to pulley 224 of rotating machine 201 through belt 226. FIGS. 2F and 2G illustrate how a CTC can increase rotating machine RPM or increase power capability with little or no alteration to existing equipment.

Belt wrap and belt contact (arc length) depicted in the schematics of FIGS. 2G and 2H are not meant to describe an absolute or fixed set of variables, but rather are used to compare relative belt wrap and belt contact and the effect modification has on the aforementioned variables. Actual application conditions and equipment geometries will have varying effects on belt wrap and belt contact and vary greatly from application to application creating wide variation in those values. When using a CTC, pulley 204 may drop slightly in elevation as compared to that depicted in FIGS. 2B and 2C. The effect on belt wrap and belt contact is such case is negligible.

Referring now to FIG. 2G, the use of CTC 200 can produce increased RPM at the rotating machine (alternator, not shown) while reducing possible belt slippage. In this configuration, pulley 202 has a diameter of 7.50″. CTC 200 comprises pulleys 204 and 220 each with a diameter of 3.00″ and shaft 222. Both pulley 204 and 220 are fixed to shaft 222 and rotate in unison. Pulley 224 of rotating machine 201 has a diameter 2.14″ and is driven by pulley 220 through synchronous belt 226. The pulley ratio between pulley 202 and pulley 204 is 7.50″:3.00″ or 2.5:1 and the pulley ratio between pulleys 220 and 224 is 3.00″:2.14″ or 1.40:1, for a combined pulley ratio of 3.5:1 between pulleys 204 and 224.

At an overall ratio of 3.5:1, the rotating machine (alternator) pulley 224 rotates at 2450 RPM when drive pulley 202 rotates at 700 RPM and 8400 RPM when drive pulley 202 rotates at 2400 RPM. This increase in RPM matches those depicted in FIGS. 2C and 2D, but without the adverse effects as a consequence of either increasing drive pulley diameter or decreasing rotating machine pulley diameter. Since the original belt wrap angle of 147° and belt contact arc length of 3.86″ are maintained, power capability at pulley 204 is also maintained. More importantly, belt 226 is a synchronous (cogged) belt further reducing the possibility of belt slippage at rotating machine pulley 224.

Referring now to FIG. 2H, the use of CTC 200 can increase overall power capability without decreasing rotating machine (alternator) RPM as depicted in FIG. 2E. In this configuration, drive pulley 202 diameter remains at 7.50″. CTC 200 comprises pulley 228 which has a diameter 4.00″ to increase power capability, pulley 232 which has a diameter of 3.0″ and shaft 222. Pulleys 228 and 232 are fixed to shaft 222 and rotate in unison. Rotating machine pulley 234 has a diameter 2.25″ and is driven by pulley 232 through synchronous belt 236. Combining pulley ratios of 7.50″:4.00″ or 1.88:1 between pulley 202 and pulley 228 and ratio 3.00″:2.25″ or 1.33:1 between pulleys 232 and 234 produces an overall ratio of 2.5:1 between pulleys 202 and 234. The overall ratio of 2.5:1 matches that depicted in FIG. 2A, but more importantly, power capability is significantly enhanced with the increase in belt wrap angle and belt contact arc length at pulley 228. Equally important, belt 236 is a synchronous belt reducing possible slippage at pulley 236.

A CTC according to the invention is not limited to solely altering RPM or increasing power, but can simultaneously do both. The unlimited number of pulley ratios and belt combinations make it possible to deliver any number of RPM and power combinations to rotating machines.

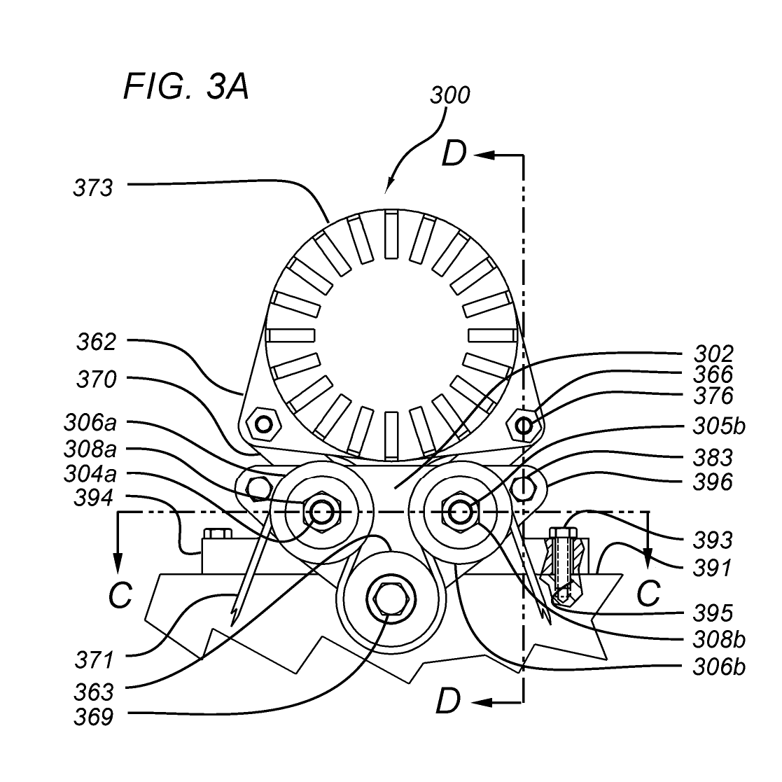

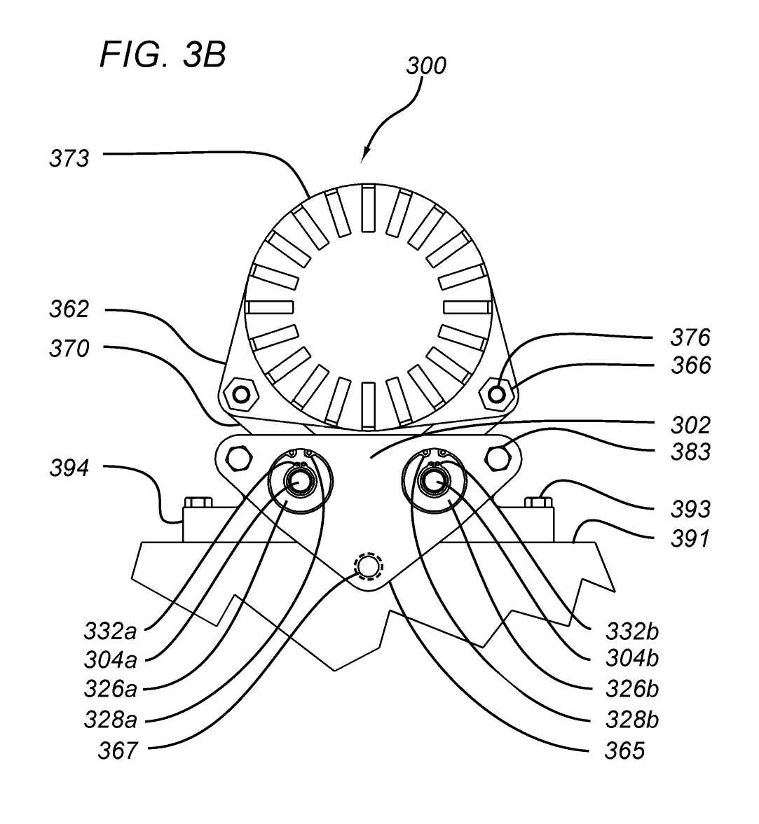

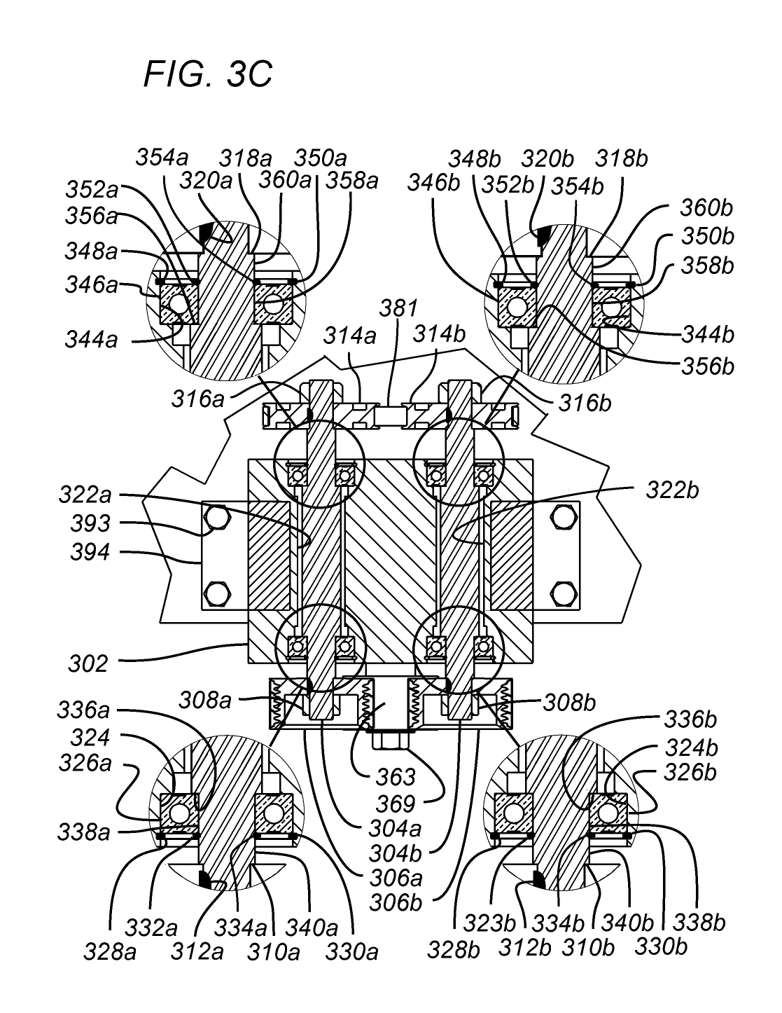

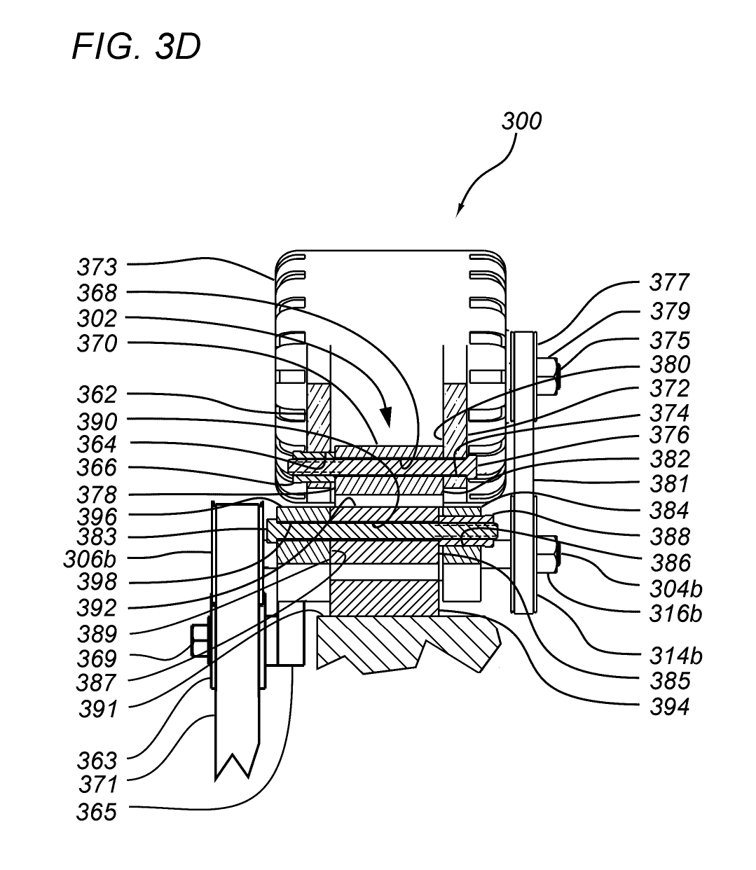

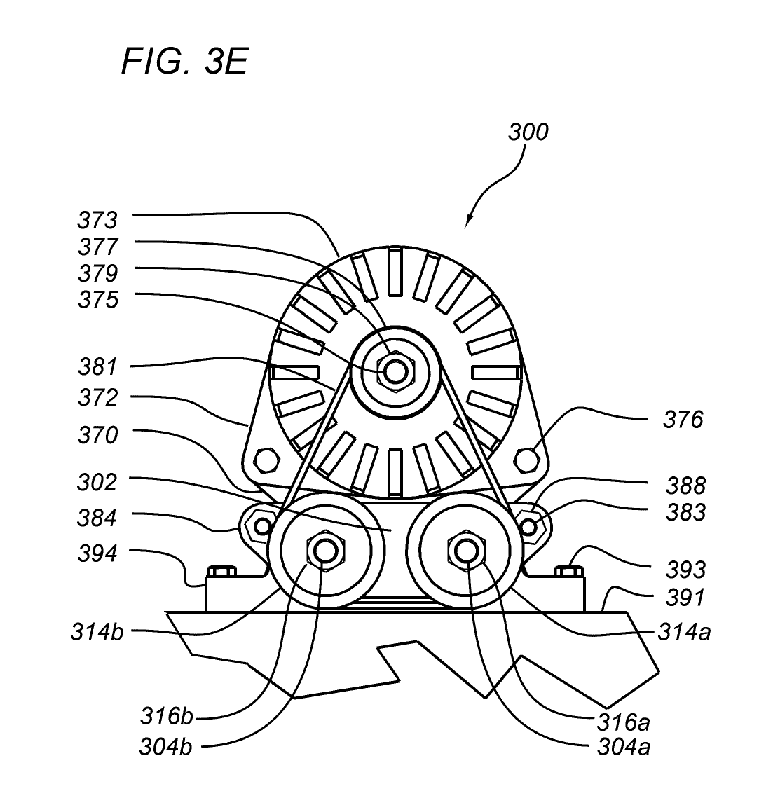

Referring now to FIGS. 3A-3E, which are collectively referred to as FIG. 3, a second embodiment of a CTC assembly 300 comprises a twin shaft CTC body 302, a first shaft 304a, and pulley 306a, which is fixed to shaft 304a by nut 308a pressing pulley 306a onto shaft surface 310a. Pulley 306a is fixed to shaft 304a by key 312a. In certain applications the friction developed between pulley 306a and shaft surface 310a by nut 308a is sufficient to eliminate the need for key 312a. Press fitting or gluing pulley 306a onto shaft 304a can also be employed to fix pulley 306a adequately onto shaft 304a. Pulley 314a is maintained on shaft 304a by nut 316a compressing pulley 314a onto shaft surface 318a. Pulley 314a is fixed to shaft 304a by key 320a. In certain applications the friction developed between pulley 314a and shaft surface 318a by nut 316a is sufficient to eliminate the need for key 320a. Press fitting or gluing pulley 314a onto shaft 304a can also be employed to fix pulley 306a adequately onto shaft 304a.

CTC 300 also comprises second shaft 304b, and pulley 306b, which is fixed to shaft 304b by nut 308b pressing pulley 306b onto shaft surface 310b. Pulley 306b is fixed to shaft 304b by key 312b. In certain applications the friction developed between pulley 306b and shaft surface 310b by nut 308b is sufficient to eliminate the need for key 312b. Press fitting or gluing pulley 306b onto shaft 304b can also be employed to fix pulley 306b adequately onto shaft 304b. Pulley 314b is maintained on shaft 304b by nut 316b pressing pulley 314b onto shaft surface 318b. Pulley 314b is fixed to shaft 304b by key 320b. In certain applications the friction developed between pulley 314b and shaft surface 318b by nut 316b is sufficient to eliminate the need for key 320b. Press fitting or gluing pulley 314b onto shaft 304b can also be employed to fix pulley 306b adequately onto shaft 304b.

CTC body 302 is preferably a die-cast or sand-cast aluminum such A356, but other suitable materials, including casting materials such as magnesium, steel, or engineered plastic such as polyamide-imide may be used. Alternatively, CTC body can be machined from a solid billet of aluminum such as type 6061-T651 or other suitable material such as magnesium, steel, engineered plastic, or other appropriate material. Shafts 304a and 304b are preferably a stress proof steel such as SAE 1144 or similar steel designed to withstand the stresses and loads that are encountered in rotating shaft applications such as alternators and pumps but can be fabricated from other materials as application requirements allow. Pulleys can be cast or machined from appropriate materials such as steel or other appropriate material.

Twin shaft body 302a contains through bore 322a. Bearing bore 324a is preferably bored to a high tolerance (e.g., +0.0001 to +0.0004 inches over nominal diameter) to accept bearing 326a and is concentric with through bore 322a. Bearing 326a is maintained in bearing bore 324a by circlip 328a seated in groove 330a. Bearing 326a is located on shaft 304a between circlip 332a seated in groove 334a and shaft surface 336a. Surface 338a on shaft 304a between groove 334a and surface 336a is preferably machined to a high tolerance (e.g., +0.0000 to −0.0003) to accept bearing 326a in assembly. Shaft surface 340a is machined with sufficient clearance to allow bearing 326a to slip past surface 340a during assembly and seat on surface 338a. Bearing bore 344a is preferably bored to a high tolerance (e.g., +0.0001 to +0.0004 inches over nominal diameter) to accept bearing 346a and is concentric with through bore 322a. Bearing 346a is maintained in bearing bore 344a by circlip 348a seated in groove 350a. Bearing 346a is axially located on shaft 304a between circlip 352a seated in groove 354a and shaft surface 356a. Surface 358a on shaft 304a between groove 354a and surface 356a is machined to a high tolerance (e.g., +0.0000 to −0.0003) to accept bearing 346a in assembly. Shaft surface 360a is machined with sufficient clearance to allow bearing 346a to slip past surface 360a during assembly and seat on surface 358a.

Through bore 322a, bearing bores 324a and 344a, and bearings 326a and 346a cooperate to align shaft 304a with through bore 322a. Bearing 326a, circlips 328a and 332a, surface 336a, bearing 346a, circlips 348a and 352a, surface 356a cooperate to fix shaft 304a in CTC assembly 300a. Nut 308a and surface 310a fix pulley 306a on shaft 304a. Key 312a radially fixes pulley 306a on shaft 304a. Nut 316a and surface 318a fix pulley 314a on shaft 304a. Key 320a fixes pulley 314a on shaft 304a.

The pulleys, shafts and methods in which they are fixed within CTC bodies and as will be described, CTC-RM assemblies, are not limited to any particular CTC application and any of the shafts described can be used in any CTC application.

CTC body 302 also contains through bore 322b. Bearing bore 324b is preferably bored to a high tolerance (e.g., +0.0001 to +0.0004 inches over nominal diameter) to accept bearing 326b and is concentric with through bore 322b. Bearing 326b is maintained in bearing bore 324b by circlip 328b seated in groove 330b. Bearing 326b is located on shaft 304b between circlip 332b seated in groove 334b and shaft surface 336b. Surface 338b on shaft 304b between groove 334b and surface 336b is preferably machined to a high tolerance (e.g., +0.0000 to −0.0003) to accept bearing 326b in assembly 300. Shaft surface 340b is preferably machined with sufficient clearance to allow bearing 326b to slip past surface 340b during assembly and seat on surface 338b. Bearing bore 344b is preferably bored to a high tolerance (e.g., +0.0001 to +0.0004 inches over nominal diameter) to accept bearing 346b and is concentric with through bore 322b. Bearing 346b is maintained in bearing bore 344b by circlip 348b seated in groove 350b. Bearing 346b is located on shaft 304b between circlip 352b seated in groove 354b and shaft surface 356b. Surface 358b on shaft 304b between groove 354b and surface 356b is preferably machined to a high tolerance (e.g., +0.0000 to −0.0003) to accept bearing 346b in assembly 300. Shaft surface 360b is machined with sufficient clearance to allow bearing 346b to slip past surface 360b during assembly and seat on surface 358b.

Through bore 322b, bearing bores 324b and 344b, and bearings 326b and 346b cooperate to align shaft 304b with through bore 322b. Bearing 326b, circlips 328b and 332b, surface 336b, bearing 346b, circlips 348b and 352b, surface 356b cooperate to fix shaft 304b in CTC assembly 300b. Nut 308b and surface 310b fix pulley 306b on shaft 304b. Key 312b fixes pulley 306b on shaft 304b. Nut 316b and surface 318b fix pulley 314b on shaft 304b. Key 320b fixes pulley 314b on shaft 304b.

Back side (smooth) idler pulley 363 is located on mounting ear 365 of CTC body 302 by bolt 369 inserted through idler pulley 363 threaded into tapped hole 367. The axis of tapped hole 367 is parallel to both axis of shafts 304a and 304b and located below the plane formed by the axis of shafts 304 and 305 on a vertical line mid way between shafts 304a and 304b. The location of tapped hole 367 is best seen in FIG. 3B. Pulleys 363, 306a and 306b are located to form a serpentine path for belt 371 that increases belt wrap angle and belt contact arc length over pulleys 306a and 306b. During operation belt 371 transmits power to both pulley 306a and 306b simultaneously as belt 371 travels over pulley 306a, across idler pulley 363, over pulley 306b then returning back to the engine drive pulley (not shown). Although it is advantageous to have idler pulley 363 mounted to CTC body 302, an idler pulley can be located remotely from CTC body 302 to replicate belt wrap around pulleys 306a and 306b afforded by mounting idler pulley 363 on CTC body 302.

Belt 371 in this embodiment is preferably a poly-v belt but that v belts designed to work with backside idlers may be used as well as roller chains, rope, or any other device suitable for transmitting power to pulley 306a and 306b.

Pulley 306a transmits power from belt 371, through shaft 304a, to pulley 314a then to belt 381. Pulley 306b transmits power from belt 371, through shaft 304b, to pulley 314b then to belt 381. Pulleys 314a and 314b simultaneously transmit power to pulley 381. Belt 381 in turn drives pulley 377 of rotating machine 373. Pulley 377 being fixed to shaft 375 by nut 379 imparts rotation to shaft 375, which in turn rotates the internal components (not shown) of the rotating machine 373 thereby producing output. Output by rotating machine 373 can be electrical power, gas compression, fluid flow or any output generated by rotating machines.

In industrial applications, the power source can be an electric motor, hydraulic motor, or pneumatic motor mounted with a pulley on the main shaft to transmit power. The use of power take offs (PTO) or other types of engine transmission auxiliary drive shafts can be equipped with pulleys to drive the rotating machine. Belt 381 in this preferred embodiment is a synchronous or ‘cogged timing’ belt. The use of synchronous belts is well known for their capability to transmit large amounts of power relative to their cross sectional area and ability to resist slippage. Although belt 381 in the preferred embodiment is a synchronous belt it can be effective using a roller chain, v-belt, poly-v belt, rope, or any other device suitable in transferring power from pulley 314a and 314b to pulley 377.

Mounting ears 362 of rotating machine 373 have holes 364 that are sized to accept threaded slip bushings 366 and align with through holes 368 of mounting ear 370 of CTC body 302. Mounting ears 372 of rotating machine 373 have clearance holes 374 that accept bolts 376 and align with through holes 368 of mounting ear 370 of CTC body 302. Bolts 376 are inserted through holes 368 and 374 and thread into slip bushing 366. When tightened, bolts 376 draw threaded slip bushings 366 against surface 378 of mounting ears 370 of CTC body 302 which in turn draws surface 380 of mounting ear 372 of rotating machine 373 against surface 382 of mounting ear 370 of CTC body 302. Holes 364, 368, and 374 in cooperation with bolts 376 and threaded slip bushings 366, fix rotating machine 373 to CTC body 302.

Mounting ears 384 of CTC body 302 have holes 386 that are sized to accept slip bushings 388 and align with through holes 390 in mounting ears 392 of bracket 394. Mounting ears 396 of CTC body 302 have holes 398 that are sized to accept bolts 383 and align with through holes 390 in mounting ears 392 of bracket 394. Bolts 383 are inserted through holes 390 and 398 and threaded into slip bushings 388. When tightened, bolts 383 draw threaded slip bushings 388 against surface 385 of mounting ears 392 which in turn draws surface 387 of mounting ears 396 against surface 389 of mounting ears 392 of bracket 394. Holes 386, 390, and 398 in cooperation with bolts 383 and slip bushings 388, fix CTC body 302 to bracket 394. Bracket 394 is fixed to mounting surface 391 with bolts 393 that align with tap holes 395 in mounting surface 391.

In automotive applications as for all of the CTCs according to the invention, mounting surface 391 would be the surface of the combustion engine itself. This is typically the case in automotive applications wherein the rotating machine, in this example an alternator, would use a bracket (394) to mount the alternator (rotating machine 373) to the engine. In applications where bracket 394 is relatively simple, the CTC can be designed to mount directly to the engine using tapped holes 395 thereby eliminating the need for bracket 394. However, the many automobile applications have complex bracket assemblies that mount many accessories. In these instances, replacing the complex bracket becomes cost prohibitive, so the ability to mount to the existing mounting features of the bracket is preferred. As with other CTCs according to the invention, in industrial applications, the mounting surface can be the floor, a support structure, or other piece of industrial equipment associated with the rotating machine.

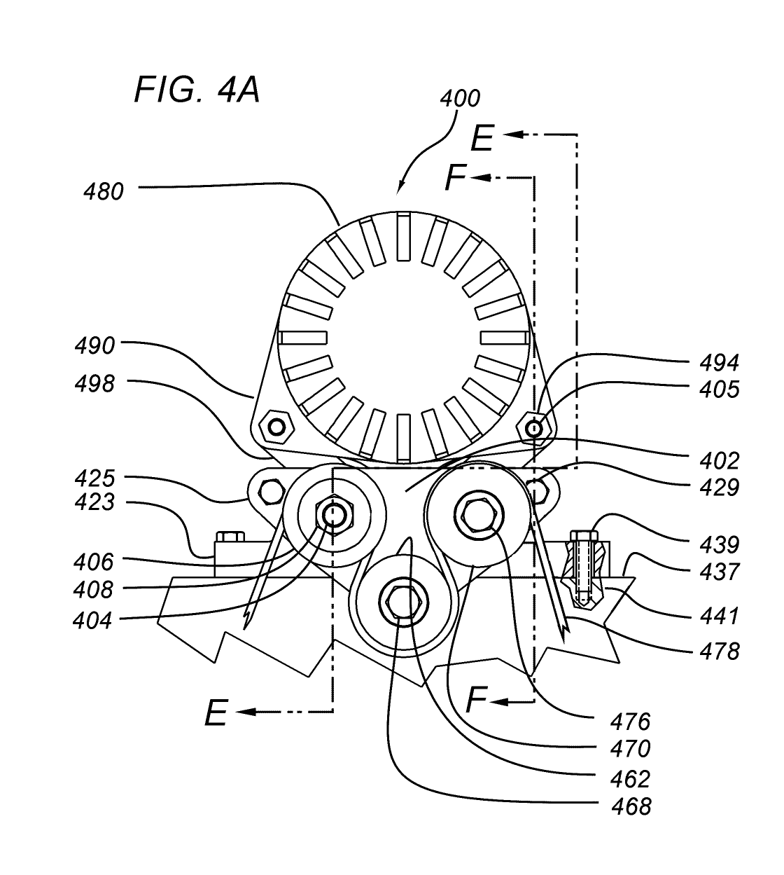

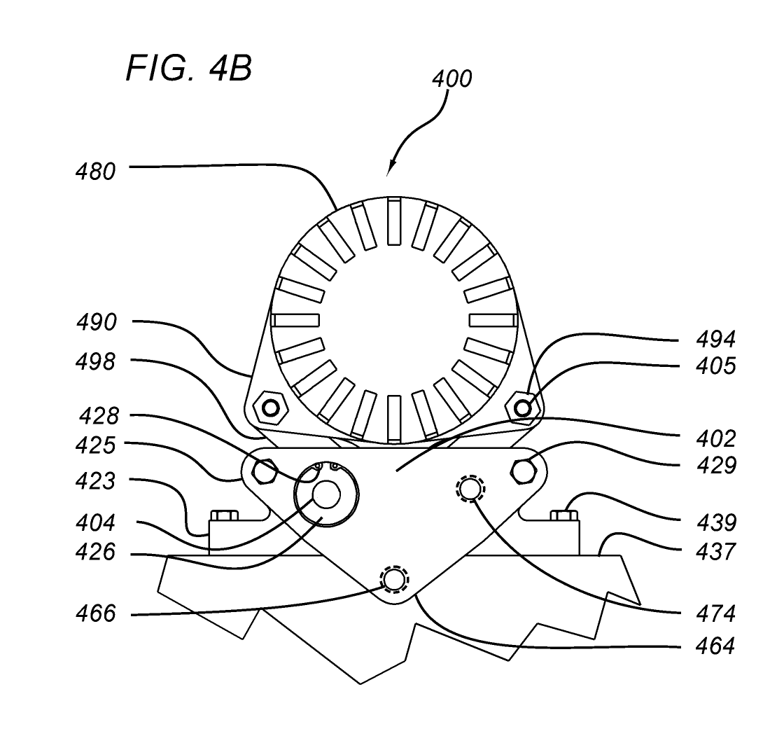

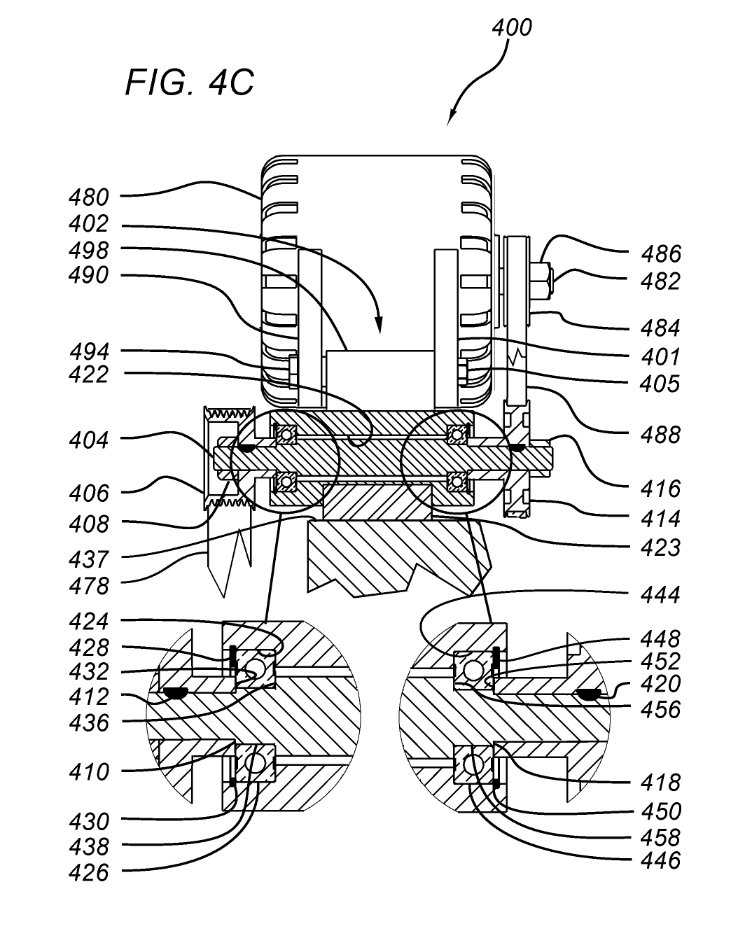

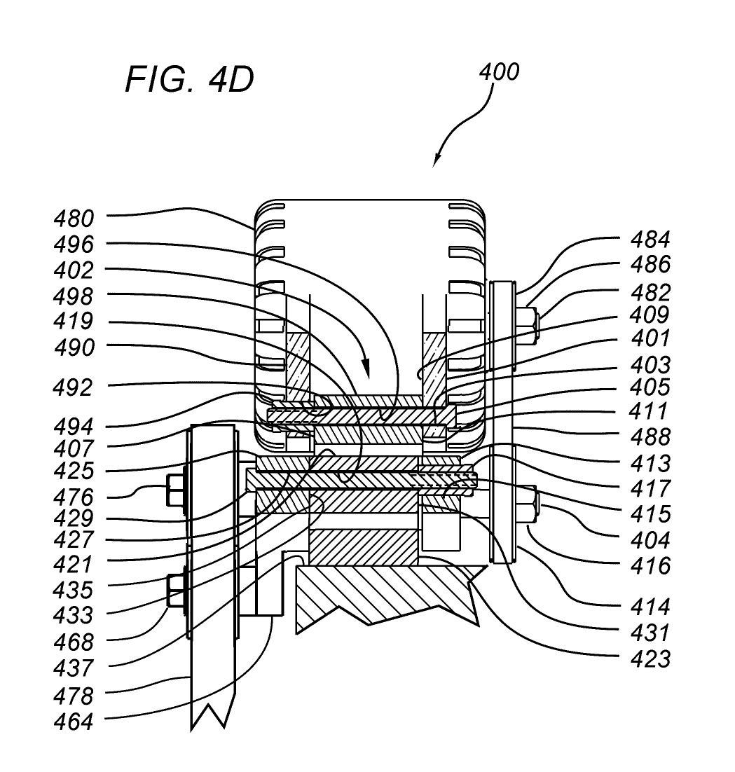

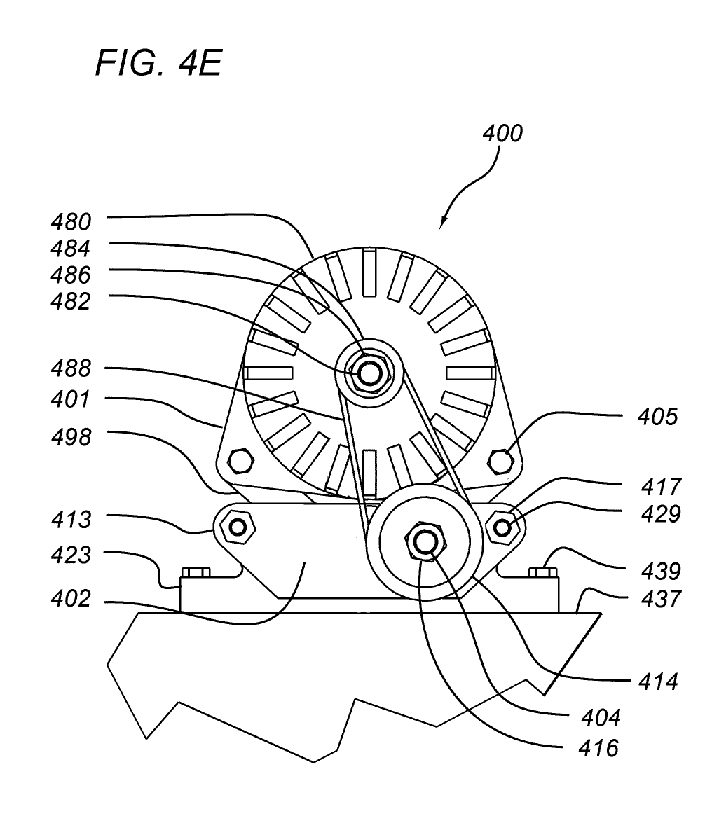

Referring now to FIGS. 4A-4E, collectively referred to as FIG. 4, a third embodiment of a CTC assembly 400 comprises CTC body 402, a shaft 404, and pulley 406 which is fixed to shaft 404 by nut 408 pressing pulley 406 onto shaft surface 410. Pulley 406 is fixed to shaft 404 by key 412. In certain applications, the friction developed between pulley 406 and shaft surface 410 by nut 408 is sufficient to resist the torque being developed eliminating the need for key 412. Press fitting or gluing pulley 406 onto shaft 404 can also be employed to fix pulley 406 adequately onto shaft 404. Pulley 414 is maintained on shaft 404 by nut 416 pressing pulley 414 onto shaft surface 418. Pulley 414 is also fixed to shaft 404 by key 420. In certain applications the friction developed between pulley 414 and shaft surface 418 by nut 416 is sufficient to eliminate the need for key 420. Press fitting or gluing pulley 414 onto shaft 404 can also be employed to fix pulley 406 adequately onto shaft 404.

CTC body 402 shaft 404 and the pulleys used in this embodiment can be made of the same materials as for previously described CTC assembly 300.

CTC body 402 contains through bore 422. Bearing bore 424 is preferably bored to a high tolerance (e.g., +0.0001 to +0.0004 inches over nominal diameter) to accept bearing 426 and is concentric with through bore 422. Bearing 426 is maintained in bearing bore 424 by circlip 428 seated in groove 430. Bearing 426 is located on shaft 404 between pulley surface 432 of pulley 406 and shaft surface 436 of shaft 404. In assembly 400 pulley surface 432 and shaft surface 410 are coplanar. Surface 438 on shaft 404 between shaft surface 410 and shaft surface 436 is preferably machined to a high tolerance (e.g., +0.0000 to −0.0003) to accept bearing 426 in assembly 400. CTC body 402 also contains bearing bore 444 which is preferably bored to a high tolerance (e.g., +0.0001 to +0.0004 inches over nominal diameter) to accept bearing 446 and is also concentric with through bore 422. Bearing 446 is maintained in bearing bore 444 by circlip 448 seated in groove 450. Bearing 446 is located on shaft 404 between pulley surface 452 of pulley 414 and shaft surface 456. In assembly 400 pulley surface 452 and shaft surface 456 are coplanar. Surface 458 on shaft 404 between pulley surface 452 and shaft surface 456 is preferably machined to a high tolerance (e.g., +0.0000 to −0.0003) to accept bearing 446 in assembly 400.

Bearing bores 424 and 444, bearings 426 and 446 cooperate to align shaft 404 in through bore 422. Bearing 426, pulley surface 432, shaft surface 436, bearing 446, pulley surface 452, and shaft surface 456 cooperate to fix shaft 404 in CTC body assembly 402. Nut 408 and surface 410 cooperate to fix pulley 406 on shaft 404. Key 412 also fixes pulley 406 on shaft 404. Nut 416 and surface 418 cooperate to fix pulley 414 on shaft 404. Key 420 also fixes pulley 414 on shaft 404.

Back side (smooth) idler pulley 462 is located on mounting ear 464 of CTC body 402 by bolt 468 inserted through pulley 462 and threaded into tapped hole 466. The axis of tapped hole 466 is parallel to the axis formed by shaft 404 and located below and to the right of the shaft 404 axis. Poly-v (grooved) idler pulley 470 is located on mounting ear 464 of CTC body 402 by bolt 476 inserted through idler pulley 470 threaded into tapped hole 474. The axis of tapped hole 474 is on the same horizontal plane formed by the shaft 404 axis and is located above and to the right of the axis of tapped hole 466. Idler pulleys 462 and 470 are located to form a serpentine path for belt 478 that increases belt wrap over pulley 406. Belt 478 is preferably a poly-v belt but vbelts designed to work with backside idler pulleys can be utilized as well as rope, or any other device suitable in transmitting power to pulley 406

Although mounting ear 464 is designed to accept idler pulleys 462 and 470, idler pulleys can alternatively be located remotely from CTC body 402 to replicate similar belt wrap around pulley 406.

During operation belt 478 transmits power to pulley 406 as belt 478 travels over pulley 406, across idler pulley 462, over idler pulley 470 then returning back to the engine crank pulley (not shown). Belt 478 is preferably a poly-v belt but other belts designed to work with backside idlers may be used as well as roller chains, rope, or any other device suitable in transmitting power to pulley 406.

Pulley 406 transmits power from belt 478 to rotating machine 480 through shaft 404, pulley 414, belt 488 then to pulley 484 of rotating machine 480. Pulley 484 being fixed to shaft 482 by nut 486 imparts rotation to shaft 482 of rotating machine 480, which in turn rotates internal components (not shown) of rotating machine 480 producing output. Output by rotating machine 480 can be electrical power, gas compression, fluid flow or any output generated by rotating machines. Belt 488 is preferably a synchronous or ‘cogged timing’ belt. The use of synchronous belts is well known for applications where their capability to transmit large amounts of power relative to their cross sectional areas are advantageous. Although belt 488 in the preferred embodiment is a synchronous belt it can use a roller chain, v-belt, poly-v belt, rope, or any other device suitable in transferring power from pulley 414 to pulley 484.

The power source can be any of those described previously for CTC assembly 300.

Mounting ears 490 of rotating machine 480 have holes 492 that are sized to accept threaded slip bushings 494 and align with through holes 496 of mounting ear 498 of CTC body 402. Mounting ears 401 of rotating machine 480 have clearance holes 403 that accept bolts 405 and align with through holes 496 of mounting ear 498 of CTC body 402. Bolts 405 are inserted through holes 496 and 403 and threaded into slip bushing 494. When tightened, bolts 405 draw threaded slip bushings 494 against surface 407 of mounting ears 498 of CTC body 402 which in turn draws surface 409 of mounting ear 401 of rotating machine 480 against surface 411 of mounting ears 498 of CTC body 402. Holes 492, 496, and 403, in cooperation with bolts 405 and threaded slip bushings 494, fix rotating machine 480 to CTC body 402.

Mounting ears 413 of CTC body 402 have holes 415 that are sized to accept slip bushings 417 and align with through holes 419 in mounting ears 421 of bracket 423. Mounting ears 425 of CTC body 402 have holes 427 that are sized to accept bolts 429 and align with through holes 419 in mounting ears 421 of bracket 423. Bolts 429 are inserted through holes 419 and 427 and thread into slip bushings 417. When tightened, bolts 429 draw threaded slip bushings 417 against surface 431 of mounting ears 413 of CTC body 402, which in turn draws surface 433 of mounting ears 425 against surface 435 of mounting ears 421 of bracket 423. Holes 415, 419, and 427, in cooperation with bolts 429 and slip bushings 417, fix CTC body 402 to bracket 423. Bracket 423 is fixed to mounting surface 437 with bolts 439 that align and thread into tap holes 441 in mounting surface 437.

In automotive applications the power source is typically an internal combustion engine and the power is transmitted from a crank pulley (not shown) which is fixed to the crank shaft (not shown) of the engine (not shown) to pulley 506. In industrial applications, the power source can be an electric motor, hydraulic motor, or pneumatic motor mounted with a pulley on the main shaft to transmit power. The use of Power take offs (PTO) or other types of engine transmission auxiliary drive shafts can be equipped with pulleys to drive the rotating machine.

The embodiments depicted in FIGS. 1, 3 and 4 describe the CTC and rotating machine (RM) operating as two distinct assemblies joined together and aligned with appropriate hardware. Those embodiments enhance an existing rotating machine, which is particularly advantageous if the existing rotating machine cannot be replaced, or it is not desirable to be replaced, but an increased torque and/or RPM can be attained by integrating the CTC with the rotating machine (RM).

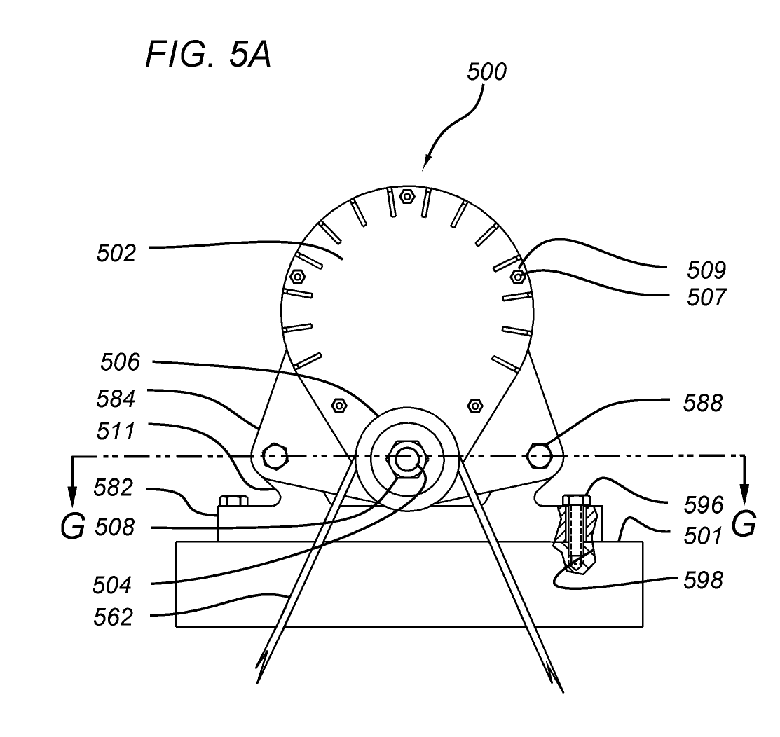

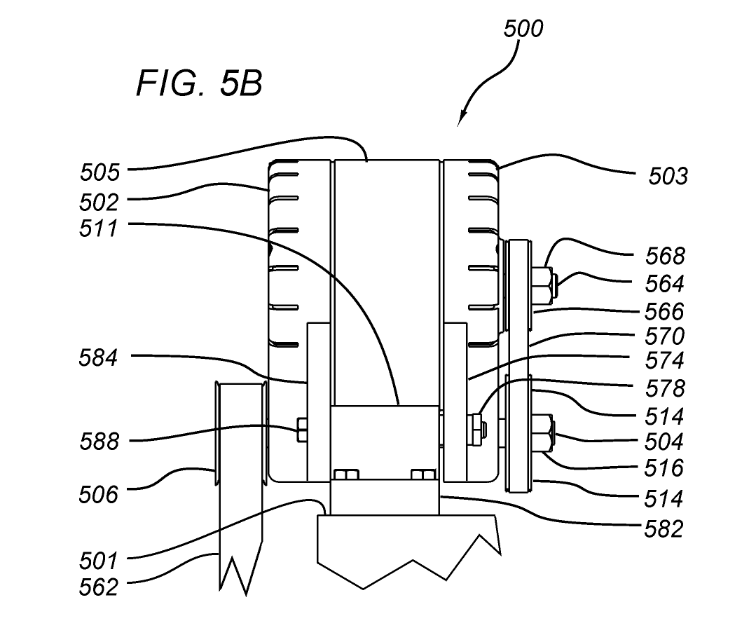

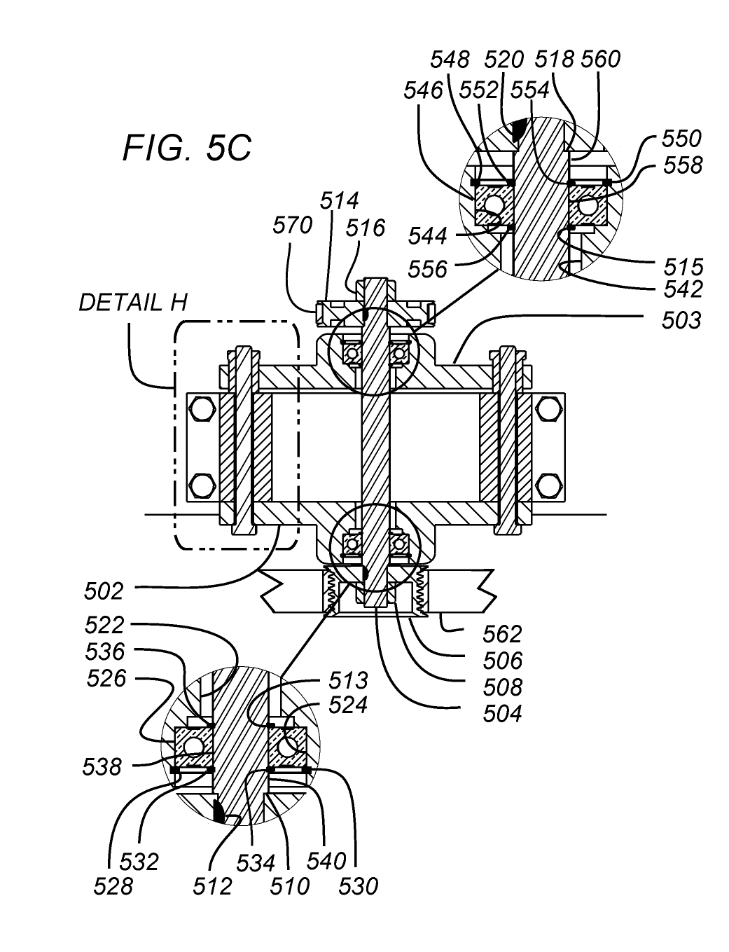

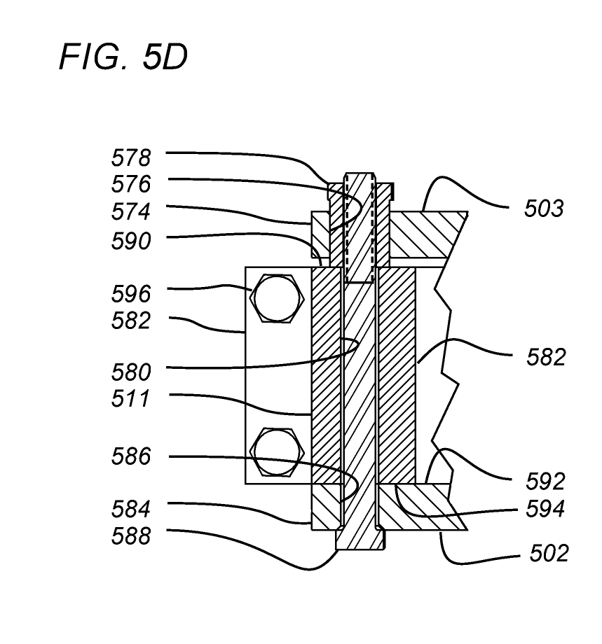

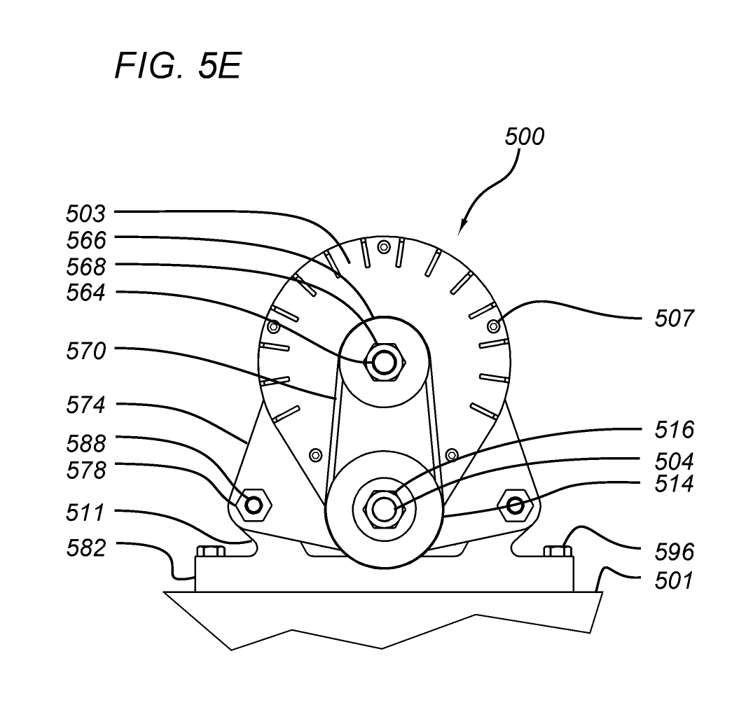

Referring now to FIGS. 5A-5E, a fourth embodiment of a CTC that integrates the CTC components with a rotating machine to produce a single CTC-RM assembly 500 is shown. Although the CTC has been integrated into a single assembly 500, the assembly 500 still has two distinct sections: (1) an RM section, which in this embodiment is depicted as an alternator, but could also be a pump, compressor, or any other rotating machine producing output through rotation, and (2) a CTC section which enhances the functionality of the rotating machine.

CTC assembly 500 comprises end bell 502, end bell 503, and stator 505 maintained and aligned between end bells 502 and 503 with socket head caps screws 507 and nuts 509. The CTC portion of CTC-RM 500 comprises a shaft 504 and pulley 506, which is fixed to shaft 504 by nut 508 pressing pulley 506 onto shaft surface 510. Pulley 506 is also fixed to shaft 504 by key 512. In certain applications the friction developed between pulley 506 and shaft surface 510 by nut 508 is sufficient to resist the torque being developed eliminating the need for key 512. Press fitting or gluing pulley 506 onto shaft 504 can also be employed to fix pulley 506 adequately onto shaft 504. Pulley 514 is maintained on shaft 504 by nut 516 pressing pulley 514 onto shaft surface 518. Pulley 514 is also fixed to shaft 504 by key 520. In certain applications the friction developed between pulley 514 and shaft surface 518 by nut 516 is sufficient to resist the torque being developed eliminating the need for key 520. Press fitting or gluing pulley 514 onto shaft 504 can also be employed to fix pulley 514 adequately onto shaft 504.

End bells 502 and 503 are preferably die cast or sand cast aluminum such A356 but can manufacture from any suitable material, such as being cast from other suitable casting material such as magnesium, steel, or engineered plastic such as polyamide-imide. The end bells can alternatively be machined from a solid billet of aluminum such as 6061-T651 or other suitable material such as magnesium, steel, engineered plastic, or other appropriate material. The shaft 504 and pulleys are preferably made of the same respective materials as described for CTC assembly 300.

Front end bell 502 contains through bore 522. Bearing bore 524 is preferably bored to a high tolerance (e.g., +0.0001 to +0.0004 inches over nominal diameter) to accept bearing 526 and is concentric with through bore 522. Bearing 526 is maintained in bearing bore 524 by circlip 528 seated in groove 530. Bearing 526 is located on shaft 504 between circlip 532 seated in groove 534 and circlip 536 seated in groove 513. Surface 538 on shaft 504 between groove 534 and 513 is preferably machined to a high tolerance (e.g., +0.0000 to −0.0003) to accept bearing 526 in assembly. Shaft surface 540 is machined with sufficient clearance to allow bearing 526 to slip past surface 540 during assembly and seat on surface 538. Rear end bell 503 contains through bore 542. Bearing bore 544 is preferably bored to a high tolerance (e.g., +0.0001 to +0.0004 inches over nominal diameter) to accept bearing 546 and is concentric with through bore 542. Bearing 546 is maintained in bearing bore 544 by circlip 548 seated in groove 550. Bearing 546 is located on shaft 504 between circlip 552 seated in groove 554 and circlip 556 seated in groove 515. Surface 558 on shaft 504 between groove 554 and groove 515 is preferably machined to a high tolerance (e.g., +0.0000 to −0.0003) to accept bearing 546 in assembly. Shaft surface 560 is machined with sufficient clearance to allow bearing 546 to slip past surface 560 during manufacture and seat on surface 558.

Through bores 522 and 542, which align in assembly 500, bearing bores 524 and 544, and bearings 526 and 546 cooperate to align shaft 504 with through bores 522 and 542. Bearing 526, circlips 528, 532 and 536, bearing 546, circlips 548, 552, and 556 cooperate to fix shaft 504 in CTC assembly 500. Nut 508 and surface 510 fix pulley 506 on shaft 504. Key 512 also fixes pulley 506 on shaft 504. Nut 516 and surface 518 fix pulley 514 on shaft 504. Key 520 also fixes pulley 514 on shaft 504.

Power is transmitted to pulley 506 from a crank pulley mounted to a power source (not shown) through belt 562. Belt 562 in this embodiment is preferably a poly-v belt but can be a roller chain, v-belt, rope, or any other device suitable in transmitting power to pulley 506. Pulley 506 transmits power from belt 562 to the rotating machine section of CTC assembly 500 through shaft 504, pulley 514, and belt 570 then to pulley 566 of the rotating machine section of CTC assembly 500. Pulley 566 being fixed to shaft 564 by nut 568 imparts rotation to shaft 564 which in turn rotates internal components (not shown) of the rotating machine section of CTC assembly 500 producing output. Output of the rotating machine section of CTC-RM 500 can be electrical power, gas compression, fluid flow or any output generated by rotating machines.

Belt 570 is preferably a synchronous or ‘cogged timing’ belt. The use of synchronous belts is well known for their capability to transmit large amounts of power relative to their cross sectional areas and ability to resist slippage. Although belt 570 in the preferred embodiment is a synchronous belt, it could also be a roller chain, v-belt, poly-v belt, rope or any other device suitable in transferring power from pulley 514 to pulley 566.

Mounting ears 574 of rear end bell 503 have holes 576 that are sized to accept threaded slip bushings 578 and align with through holes 580 in mounting ears 511 of bracket 582. Mounting ears 584 of front end bell 502 have clearance holes 586 that accept bolts 588 and align with through holes 580 of mounting ear 511 of bracket 582. Bolts 588 are inserted through holes 580 and 586 and thread into slip bushing 578. When tightened, bolts 588 draw threaded slip bushings 578 against surface 590 of mounting ear 511 of bracket 582, which in turn draws surface 592 of mounting ear 584 against surface 594 of mounting ear 511 of bracket 582. Holes 576, 580, and 586 in cooperation with bolts 588 and threaded slip bushings 578, fix CTC-RM 500 to bracket 582. Bracket 582 is fixed to mounting surface 501 with bolts 596 that align with tap holes 598 in mounting surface 501.

For automotive applications, mounting surface 501 could be the surface of the combustion engine itself. This is typically the case in automotive applications where CTC-RM 500 would utilize a bracket (582) to mount CTC assembly 500 to the engine. In applications where bracket 582 is relatively simple, CTC assembly 500 can be designed to fit directly to surface 501 thereby eliminating the need for bracket 582. However, many automobile applications have complex bracket assemblies. In these instances, replacing the complex bracket is cost prohibitive, and the ability to mount CTC assembly to the existing mounting bracket is advantageous. In industrial applications, the mounting surface can be the floor, a support structure, or other piece of industrial equipment associated with the rotating machine.

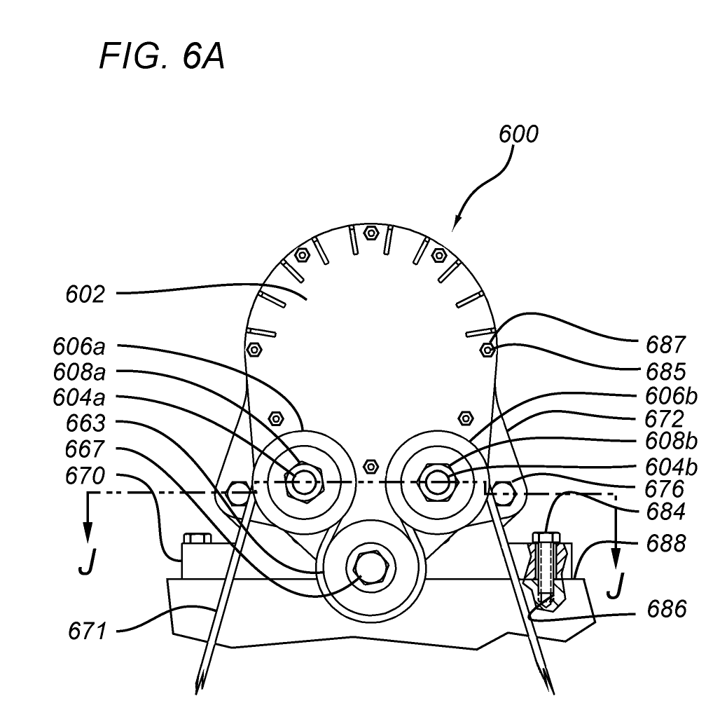

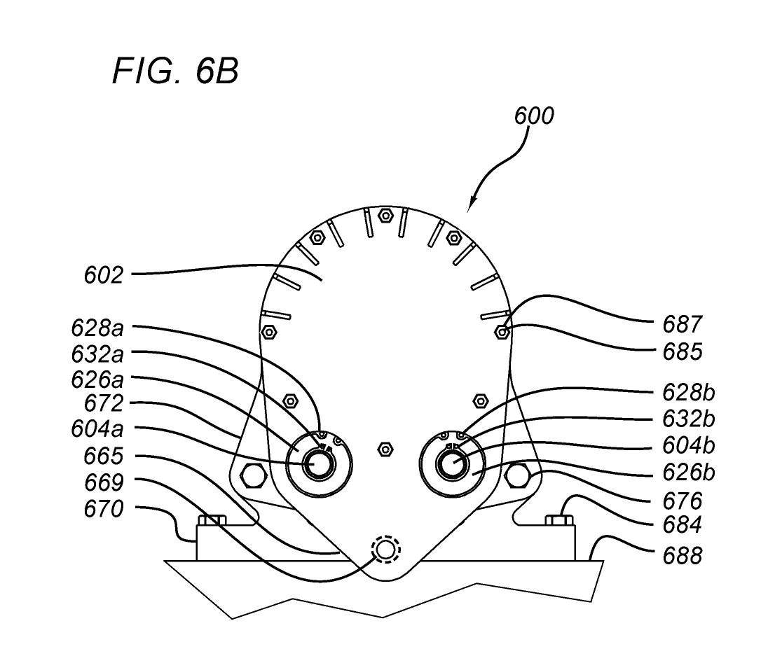

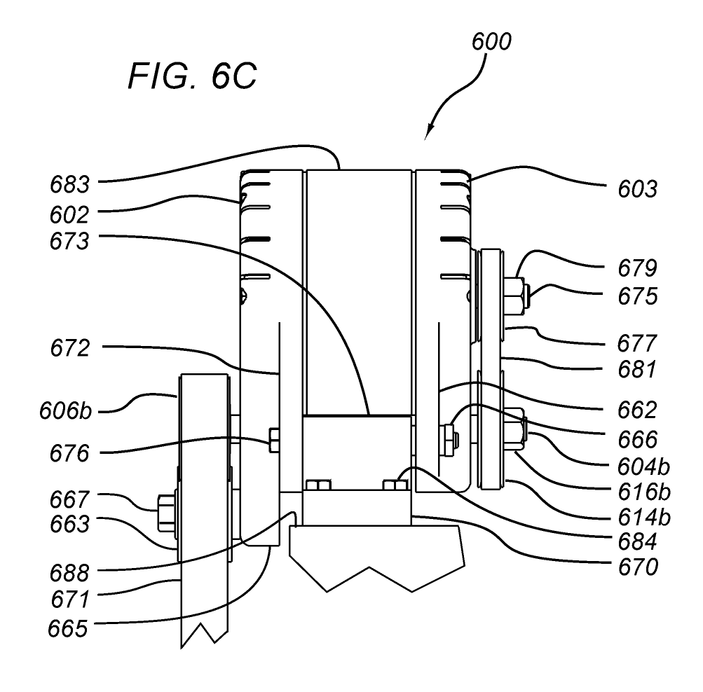

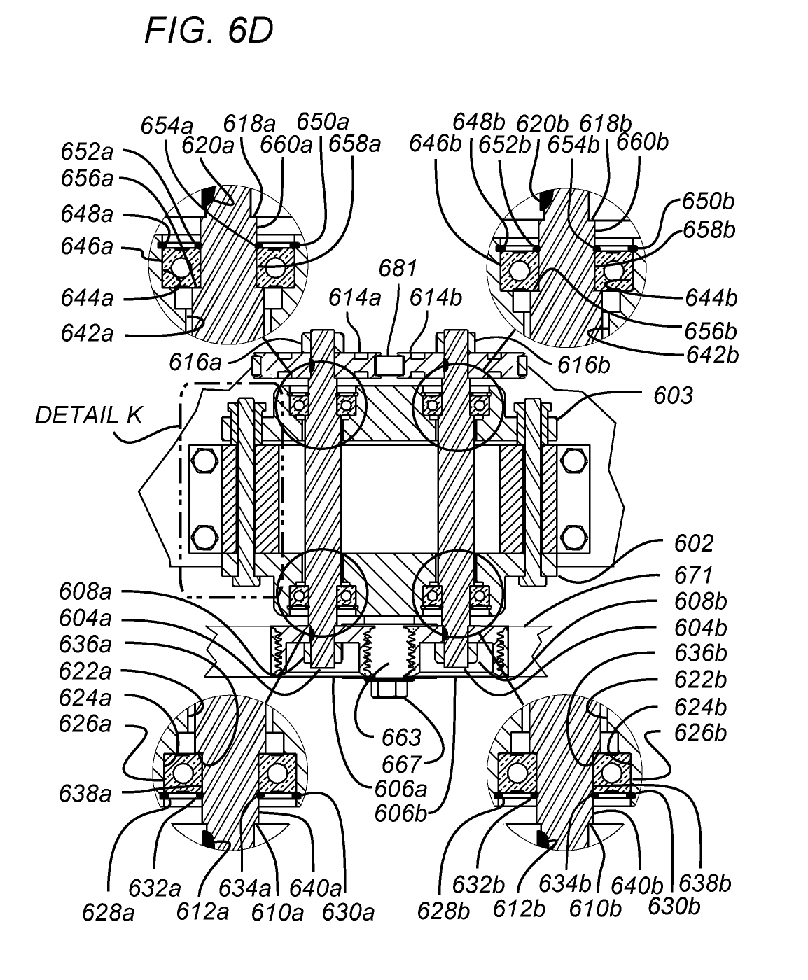

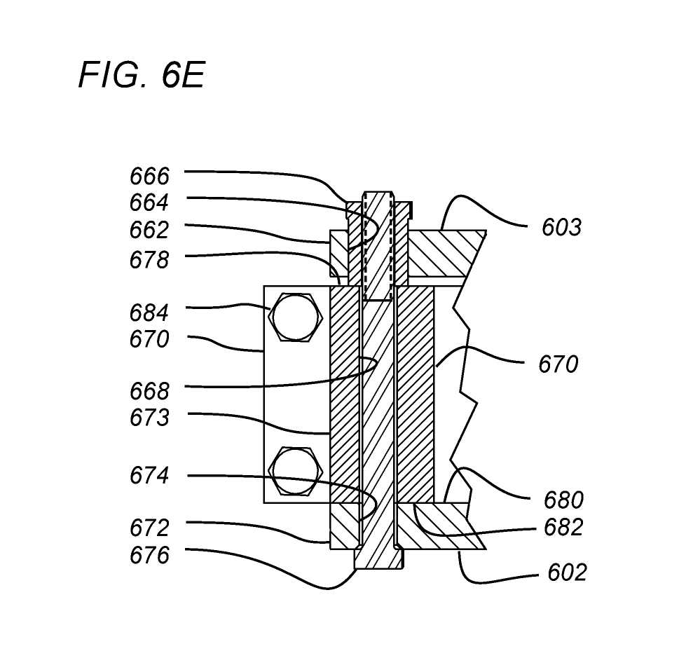

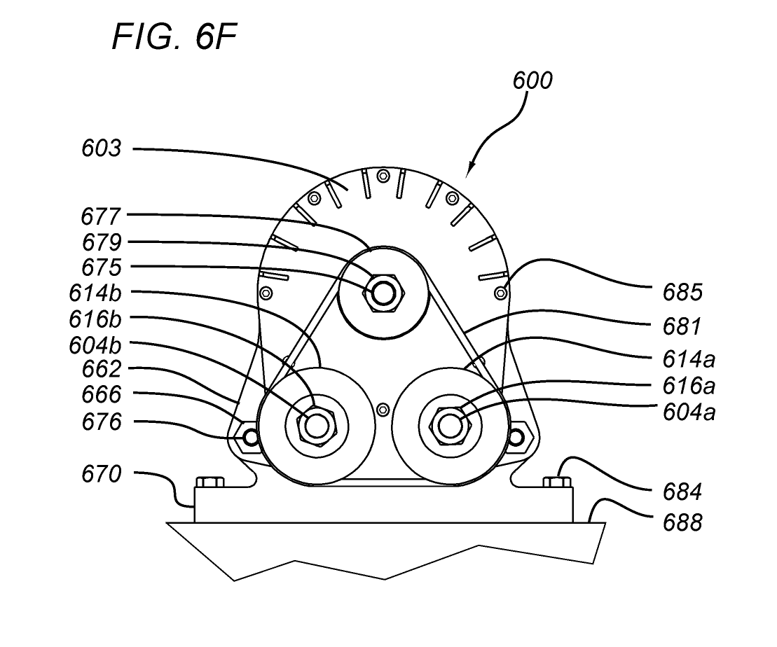

Referring now to FIG. 6A-6F, collectively referred to as FIG. 6, a fifth embodiment of a CTC that integrates the CTC components and the rotating machine to produce a single assembly 600. Although the CTC components have been integrated into a single unit, the assembly still has two distinct sections: (1) an RM section, which in this embodiment is depicted as an alternator but can equally apply to a pump, compressor, or any other output device produced by rotating machinery, and (2) a CTC section which enhances the functionality of the RM section.

CTC assembly 600 comprises front end bell 602 and rear end bell 603. Stator 683 is maintained and aligned between end bells 602 and 603 with socket head caps screws 685 and nuts 687.

The CTC section of CTC assembly 600 is essentially of the same design as CTC assembly 300. It comprises shaft 604a and pulley 606a, which is fixed to shaft 604a by nut 608a pressing pulley 606a onto shaft surface 610a. Pulley 606a is also fixed to shaft 604a by key 612a. In certain applications the friction developed between pulley 606a and shaft surface 610a by nut 608a is sufficient to eliminate the need for key 612a. Press fitting or gluing pulley 606a onto shaft 604a can also be employed to fix pulley 606a adequately onto shaft 604a. Pulley 614a is maintained on shaft 604a by nut 616a pressing pulley 614a onto shaft surface 618a. Pulley 614a is also fixed to shaft 604a by key 620a. In certain applications the friction developed between pulley 614a and shaft surface 618a by nut 616a is sufficient to eliminate the need for key 620a. Press fitting or gluing pulley 614a onto shaft 604a can also be employed to fix pulley 606a adequately onto shaft 604a.

CTC assembly 600 also comprises second shaft 604b and pulley 606b which is fixed to shaft 604b by nut 608b pressing pulley 606b onto shaft surface 610b. Pulley 606b is also fixed to shaft 604b by key 612b. In certain applications the friction developed between pulley 606b and shaft surface 610b by nut 608b is sufficient to eliminate the need for key 612b. Press fitting or gluing pulley 606b onto shaft 604b can also be employed to fix pulley 606b adequately onto shaft 604b. Pulley 614b is maintained on shaft 604b by nut 616b pressing pulley 614b onto shaft surface 618b. Pulley 614b is also fixed to shaft 604b by key 620b. In certain applications the friction developed between pulley 614b and shaft surface 618b by nut 616b is sufficient to eliminate the need for key 620b. Press fitting or gluing pulley 614b onto shaft 604b can also be employed to fix pulley 606b adequately onto shaft 604b.

End bells 602 and 603, shafts 604 and 505 and the pulleys used in CTC assembly 600 are preferably made of the same respective materials as described for CTC assembly 500.

Front end bell 602 contains through bore 622a. Bearing bore 624a is preferably bored to a high tolerance (e.g., +0.0001 to +0.0004 inches over nominal diameter) to accept bearing 626a and is concentric with through bore 622a. Bearing 626a is maintained in bearing bore 624a by circlip 628a seated in groove 630a. Bearing 626a is located on shaft 604a between circlip 632a seated in groove 634a and shaft surface 636a. Surface 638a on shaft 604a between groove 634a and surface 636a is preferably machined to a high tolerance (e.g., +0.0000 to −0.0003) to accept bearing 626a in assembly 600. Shaft surface 640a is machined with sufficient clearance to allow bearing 626a to slip past surface 640a during manufacture and seat on surface 638a. Rear end bell 603a contains through bore 642a. Bearing bore 644a is preferably bored to a high tolerance (e.g., +0.0001 to +0.0004 inches over nominal diameter) to accept bearing 646a and is concentric with through bore 642a. Bearing 646a is maintained in bearing bore 644a by circlip 648a seated in groove 650a. Bearing 646a is located on shaft 604a between circlip 652a seated in groove 654a and shaft surface 656a. Surface 658a on shaft 604a between groove 654a and surface 656a is preferably machined to a high tolerance (e.g., +0.0000 to −0.0003) to accept bearing 646a in assembly 600. Shaft surface 660a is machined with sufficient clearance to allow bearing 646a to slip past surface 660a during manufacture and seat on surface 658a.

Through bores 622a and 642a, which align in assembly 600, bearing bores 624a and 644a, and bearings 626a and 646a, cooperate to align shaft 604a with through bores 622a and 642a. Bearing 626a, circlips 628a and 632a, surface 636a, bearing 646a, circlips 648a and 652a, and surface 656a cooperate to fix shaft 604a in CTC-RM assembly 600a. Nut 608a and surface 610a fix pulley 606a on shaft 604a. Key 612a fixes pulley 606a on shaft 604a. Nut 616a and surface 618a fix pulley 614a on shaft 604a. Key 620a fixes pulley 614a on shaft 604a.

Front end bell 602 also contains through bore 622b. Bearing bore 624b is preferably bored to a high tolerance (e.g., +0.0001 to +0.0004 inches over nominal diameter) to accept bearing 626b and is concentric with through bore 622b. Bearing 626b is maintained in bearing bore 624b by circlip 628b seated in groove 630b. Bearing 626b is located on shaft 604b between circlip 632b seated in groove 634b and shaft surface 636b. Surface 638b on shaft 604b between groove 634b and surface 636b is preferably machined to a high tolerance (e.g., +0.0000 to −0.0003) to accept bearing 626b in assembly. Shaft surface 640b is machined with sufficient clearance to allow bearing 626b to slip past surface 640b during assembly and seat on surface 638b. Rear end bell 603b contains through bore 642b. Bearing bore 644b is preferably bored to a high tolerance (e.g., +0.0001 to +0.0004 inches over nominal diameter) to accept bearing 646b and is concentric with through bore 642b. Bearing 646b is maintained in bearing bore 644b by circlip 648b seated in groove 650b. Bearing 646b is located on shaft 604b between circlip 652b seated in groove 654b and shaft surface 656b. Surface 658b on shaft 604b between groove 654b and surface 656b is preferably machined to a high tolerance (e.g., +0.0000 to −0.0003) to accept bearing 646b in assembly 600. Shaft surface 660b is machined with sufficient clearance to allow bearing 646b to slip past surface 660b during manufacture and seat on surface 658b.

Through bores 622b and 642b, which align in assembly 600, bearing bores 624b and 644b, and bearings 626b and 646b, cooperate to align shaft 604b with through bores 622b and 642b. Bearing 626b, circlips 628b and 632b, surface 636b, bearing 646b, circlips 648b and 652b, and surface 656b cooperate to fix shaft 604b in CTC-RM assembly 600b. Nut 608b and surface 610b fix pulley 606b on shaft 604b. Key 612b fixes pulley 606b on shaft 604b. Nut 616b and surface 618b fix pulley 614b on shaft 604b. Key 620b fixes pulley 614b on shaft 604b.

Back side (smooth) idler pulley 663 is fixed to mounting ear 665 of front end bell 602 by bolt 667 inserted through pulley 663 and threaded into tapped hole 669. The axis of tapped hole 669 is preferably parallel to the axis of shafts 604a and 604b and is located below the plane formed by the axes of shafts 604a and 604b on a vertical line mid way between shafts 604a and 604b. The location of pulleys 663, 606a, and 606b form a serpentine path for belt 671 that increases belt wrap length. Belt 671 is preferably a poly-v belt but other devices designed to work with backside idlers can also be utilized as well as roller chain, rope, or any other device suitable in transmitting power to pulleys 606a and 606b.

During operation belt 671 transmits power to both pulley 606a and 606b simultaneously as belt 671 travels over pulley 606a, across idler pulley 663, over pulley 606b then returning back to the engine crank pulley (not shown). Although it is advantageous to have idler pulley 663 mounted to CTC body 602, an idler pulley can be located remotely from CTC body 602 to replicate belt wrap afforded by mounting idler pulley 663 on CTC body 602. Belt 671 in this embodiment is preferably a poly-v belt but any other belts or devices designed to work with backside idlers may be used as well as roller chains, rope, or any other device suitable in transmitting power to pulley 606a and 606b.

Pulley 606a transmits power from belt 671, through shaft 604a, to pulley 614a then to belt 681. Pulley 606b transmits power from belt 671, through shaft 604b, to pulley 614b then to belt 681. Pulleys 606a and 606b simultaneously transmit power to belt 681. Belt 681 drives pulley 677 of the RM portion of CTC assembly 600. Pulley 677 is fixed to shaft 675 by nut 679 and imparts rotation to shaft 675, which in turn rotates the internal components (not shown) of the rotating machine section of CTC assembly 600 thereby producing output. Output by rotating machine section of CTC assembly 600 can be electrical power, gas compression, fluid flow or any output generated by rotating machines. Belt 681 is preferably a synchronous or ‘cogged timing’ belt. Synchronous belts are well known for their capability to transmit large amounts of power relative to their cross sectional areas and ability to resist slippage. Although belt 681 in the preferred embodiment is a synchronous belt, it could be a roller chain, v-belt, poly-v belt, rope, or any other device suitable in transferring power from pulleys 614 and 615 to pulley 677.

Mounting ears 662 of rear end bell 603 have holes 664 that are sized to accept threaded slip bushings 666 and align with through holes 668 in mounting ears 673 of bracket 670. Mounting ears 672 of front end bell 602 have clearance holes 674 that accept bolts 676 and align with through holes 668 in mounting ear 673 of bracket 670. Bolts 676 are inserted through holes 668 and 674 and threaded into slip bushing 666. When tightened, bolts 676 draw threaded slip bushings 666 against surface 678 of mounting ear 673 of bracket 670 which in turn draws surface 680 of mounting ear 672 against surface 682 of mounting ear 673 of bracket 670. Holes 664, 668, and 674 in cooperation with bolts 676 and threaded slip bushings 666, fix CTC assembly 600 to bracket 670. Bracket 670 is fixed to mounting surface 688 with bolts 684 that align with tap holes 686 in mounting surface 688. CTC assembly 600 is preferably mounted in the same manner as described for CTC assembly 500.

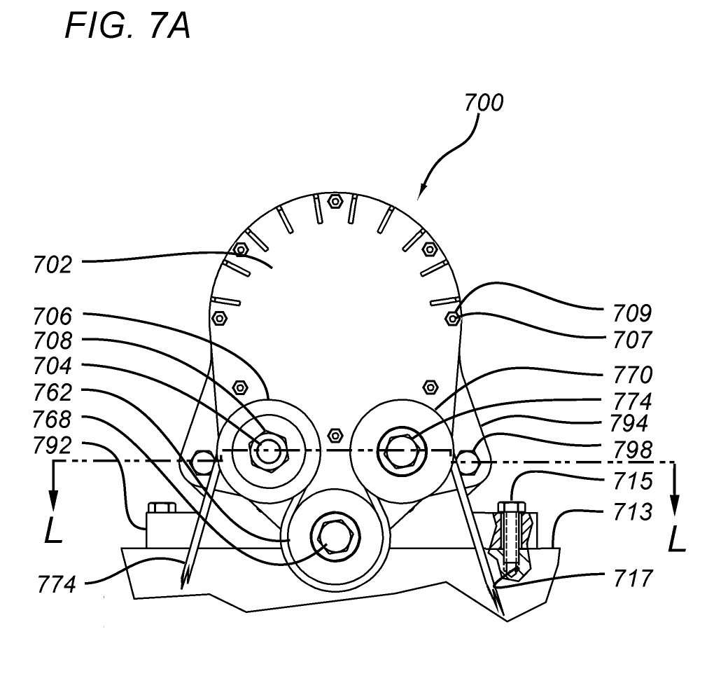

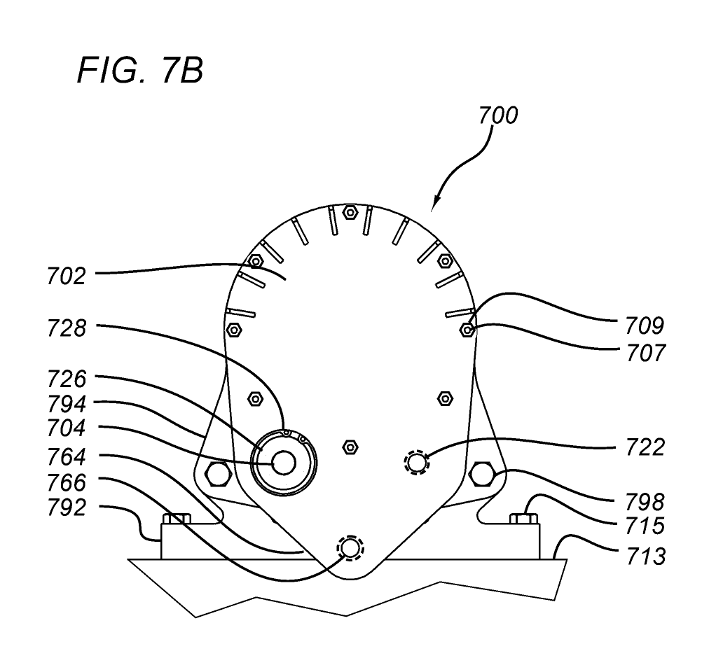

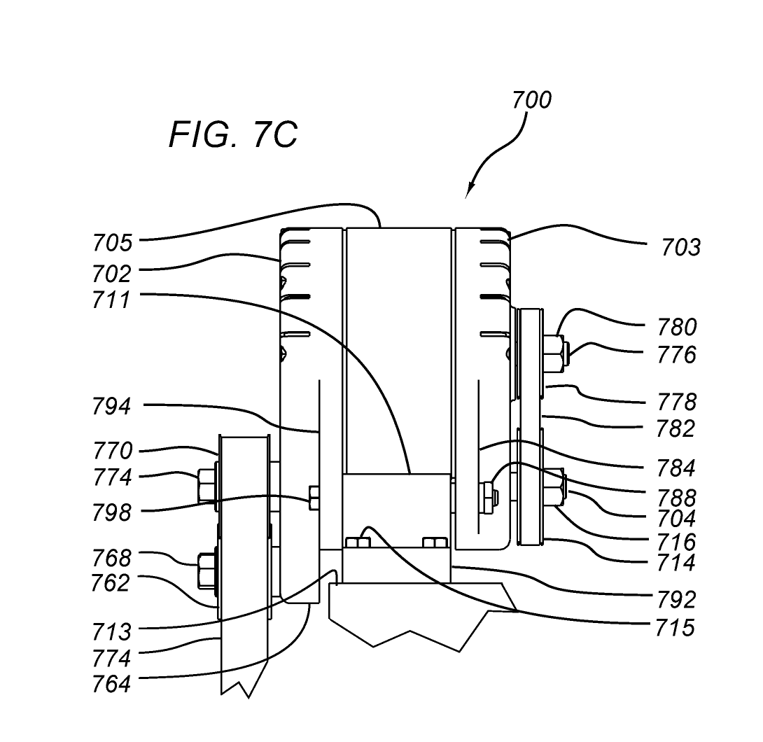

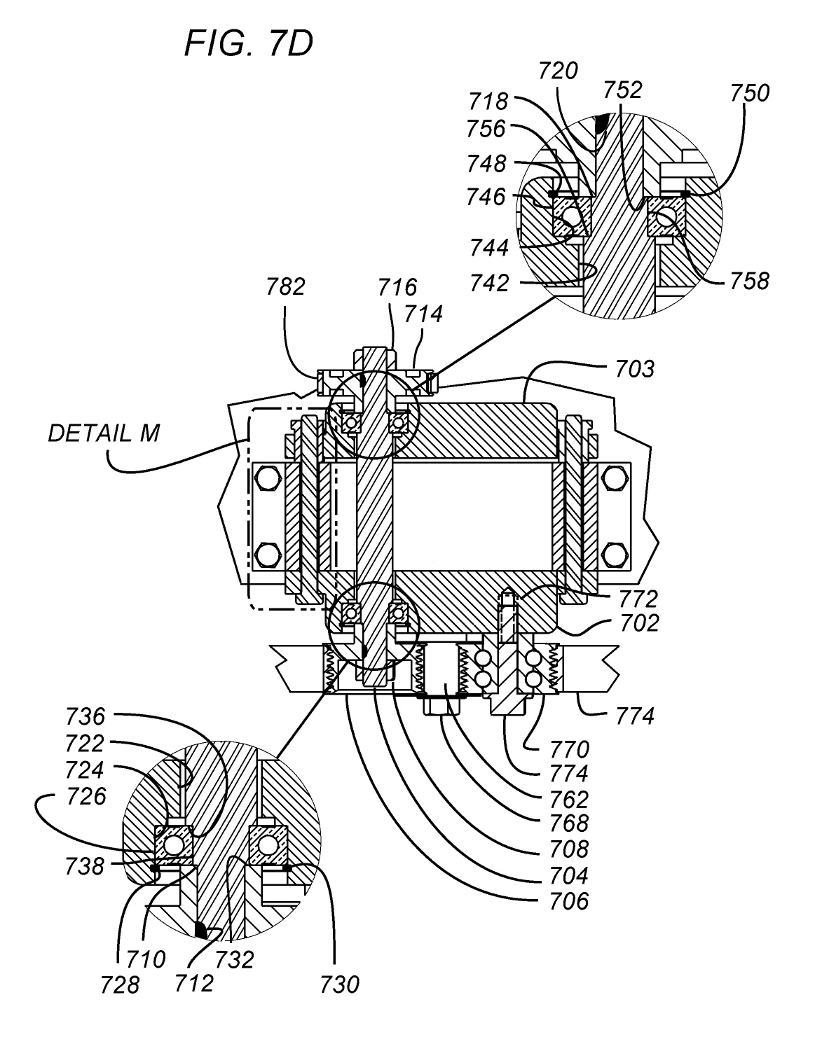

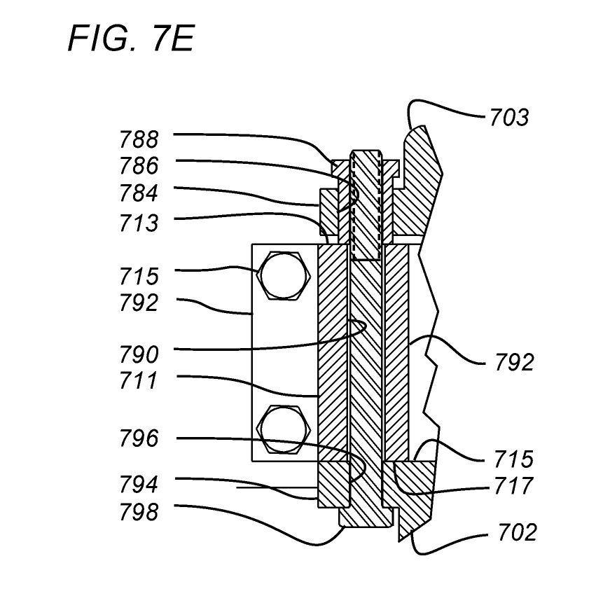

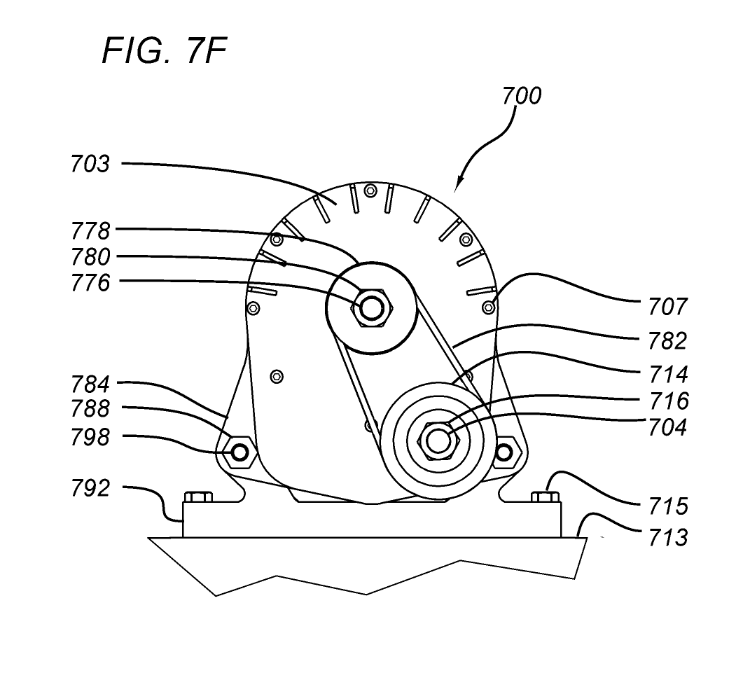

Referring now to FIGS. 7A-7F, collectively referred to as FIG. 7, a sixth embodiment of a CTC integrates the CTC components and the rotating machine RM to produce a single assembly 700. Although the CTC has been integrated into a single unit, the assembly still has two distinct sections: (1) an RM section, which in this embodiment is depicted as an alternator but can equally apply to a pump, compressor, or any other output device produced by rotating machinery, and (2) a CTC section, which enhances the functionality of the rotating machine. CTC assembly 700 comprises front end bell 702 and rear end bell 703 a stator 705, which is maintained and aligned between end bells 702 and 703 by socket head caps screws 707 and nuts 709.

CTC assembly 700 also comprises a shaft 704 and pulley 706, which is fixed to shaft 704 by nut 708 compressing pulley 706 onto shaft surface 710. Pulley 706 is also fixed to shaft 704 by key 712. In certain applications the friction developed between pulley 706 and shaft surface 710 by nut 708 is sufficient to resist the torque being developed eliminating the need for key 712. Press fitting or gluing pulley 706 onto shaft 704 also can be employed to fix pulley 706 adequately onto shaft 704. Pulley 714 is maintained on shaft 704 by nut 716 pressing pulley 714 onto shaft surface 718. Pulley 714 is also fixed to shaft 704 by key 720. In certain applications the friction developed between pulley 714 and shaft surface 718 by nut 716 is sufficient to eliminate the need for key 720. Press fitting or gluing pulley 714 onto shaft 704 can also be employed to fix pulley 706 adequately onto shaft 704.

End bells 702 and 703, shafts 704 and 705 are preferably formed, respectively, of the same materials as described for CTC assembly 500.

Front end bell 702 contains through bore 722. Bearing bore 724 is preferably bored to a high tolerance (e.g., +0.0001 to +0.0004 inches over nominal diameter) to accept bearing 726 and is concentric with through bore 722. Bearing 726 is maintained in bearing bore 724 by circlip 728 seated in groove 730. Bearing 726 is located on shaft 704 between pulley surface 732 and shaft surface 736. Surface 738 on shaft 704 between surface 732 and surface 710 is preferably machined to a high tolerance (e.g., +0.0000 to −0.0003) to accept bearing 726. In assembly pulley surface 732 and shaft surface 738 are coplanar. Rear end bell 703 contains through bore 742. Bearing bore 744 is preferably bored to a high tolerance (e.g., +0.0001 to +0.0004 inches over nominal diameter) to accept bearing 746 and is concentric with through bore 742. Bearing 746 is maintained in bearing bore 744 by circlip 748 seated in groove 750. Bearing 746 is located on shaft 704 by pulley surface 752 and shaft surface 756. Surface 758 on shaft 704 between surface 752 and surface 720 is preferably machined to a high tolerance (e.g., +0.0000 to −0.0003) to accept bearing 746. In CTC assembly 700 pulley surface 752 and shaft surface 756 are coplanar.

Through bores 722 and 742, which align in assembly 700, bearing bores 724 and 744, bearings 726 and 746 cooperate to align shaft 704 in through bores 722 and 742. Bearing 726, circlip 728, surface 732 and 736, bearing 746, surface 752 and 756 cooperate to fix shaft 704 in CTC assembly 700. Nut 708 and surface 710 fix pulley 706 on shaft 704. Key 712 fixes pulley 707 on shaft 704. Nut 716 and surface 718 fix pulley 714 on shaft 704. Key 720 also fixes pulley 714 on shaft 704.

Back side (smooth) idler pulley 762 is located on mounting ear 764 of front end bell 702 by bolt 768 inserted through idler pulley 762 threaded into tapped hole 766. The axis of tapped hole 766 is parallel to the axis of shaft 704 and is located below and to the right of the shaft 704 axis. Poly-v (grooved) idler pulley 770 is also located on mounting ear 764 of front end bell 702 by bolt 774 inserted through idler pulley 770 threaded into tapped hole 772. The axis of tapped hole 772 is preferably on the same horizontal plane formed by the shaft 704 axis and is located above and to the right of the axis of tapped hole 766. Pulleys 762, 706, and 707 are located to form a serpentine path for belt 774 that increases belt wrap over pulley 706. During operation belt 774 transmits power to pulley 706 as belt 774 travels over pulley 706, across idler pulley 762, over idler pulley 770 then returning back to the engine crank pulley (not shown). Belt 774 is preferably a poly-v belt, but any belts or other devices designed to work with backside idlers may be used as well as roller chains, rope, or any other device suitable in transmitting power to pulley 706.

Pulley 702 transmits power from belt 774 to the rotating machine section of CTC assembly 700 through shaft 704, pulley 714, and belt 782 then to pulley 778 of the rotating machine section of CTC assembly 700. Pulley 778 is fixed to shaft 776 by nut 780 and imparts rotation to shaft 776 of the rotating machine section of CTC assembly 700 which in turn rotates internal components (not shown) of rotating machine section of CTC assembly 700 producing output. Output by the rotating machine section of CTC assembly 700 can be electrical power, gas compression, fluid flow or any output generated by rotating machines.

Idler pulleys 762 and 770 can be located remotely from front end bell 702 thereby replicating similar belt wrap around pulley 706.

In automotive applications the power source is typically an internal combustion engine and the power is transmitted from a crank pulley (not shown) which is fixed to the crank shaft (not shown) of the engine (not shown) to pulley 706. In industrial applications, the power source can be an electric motor, hydraulic motor, or pneumatic motor mounted with a pulley on the main shaft to transmit power. The use of Power take offs (PTO) or other types of engine transmission auxiliary drive shafts can be equipped with pulleys to drive the rotating machine. Belt 782 in this embodiment is a synchronous or ‘cogged timing’ belt. The use of synchronous belts is well known for their capability to transmit large amounts of power relative to their cross sectional areas and ability to resist slippage. Although belt 782 in the preferred embodiment is a synchronous belt, it could also be a roller chain, v-belt, poly-v belt, rope, or any other device suitable in transferring power from pulley 714 to pulley 778.

Mounting ears 784 of rear end bell 703 have holes 786 that are sized to accept threaded slip bushings 788 and align with through holes 790 in mounting ears 711 of bracket 792. Mounting ears 794 of front end bell 702 have clearance holes 796 that accept bolts 798 and align with through holes 790 of mounting ear 711 of bracket 792. Bolts 798 are inserted through holes 790 and 796 and thread into slip bushing 788. When tightened, bolts 798 draw threaded slip bushings 788 against surface 713 of mounting ear 711 of bracket 792 which in turn draws surface 715 of mounting ear 794 against surface 717 of mounting ear 711 of bracket 792. Holes 786, 790, and 796, in cooperation with bolts 798 and threaded slip bushings 788, fix CTC assembly 500 to bracket 792. Bracket 792 is fixed to mounting surface 713 with bolts 715 that align with tap holes 717 in mounting surface 713.

CTC assembly 700 would preferably be mounted in the same manner as CTC assembly 500.

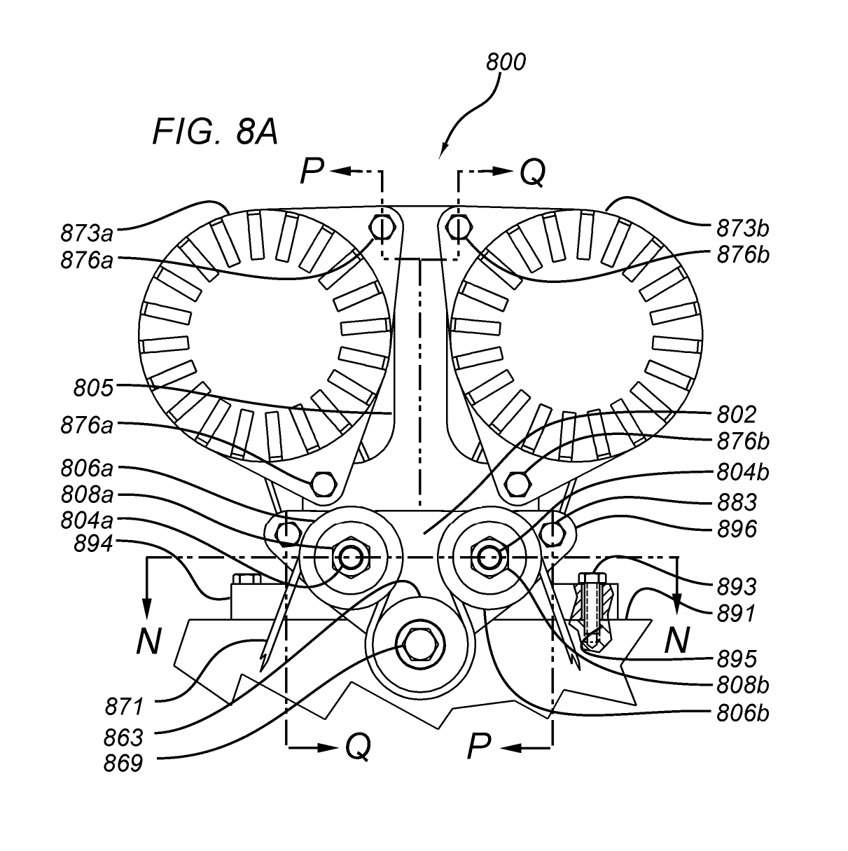

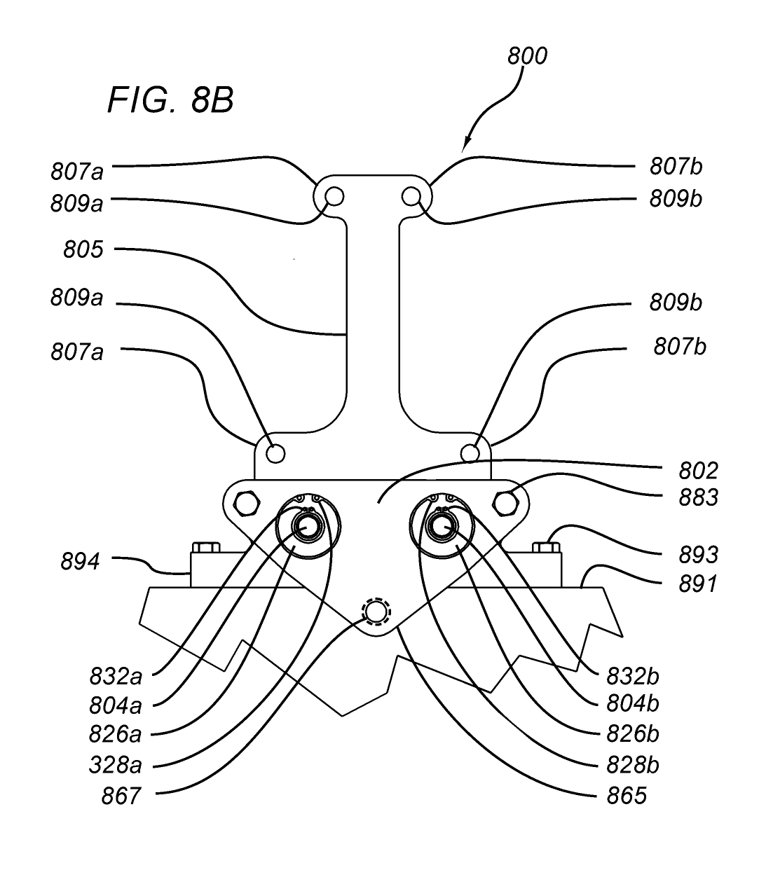

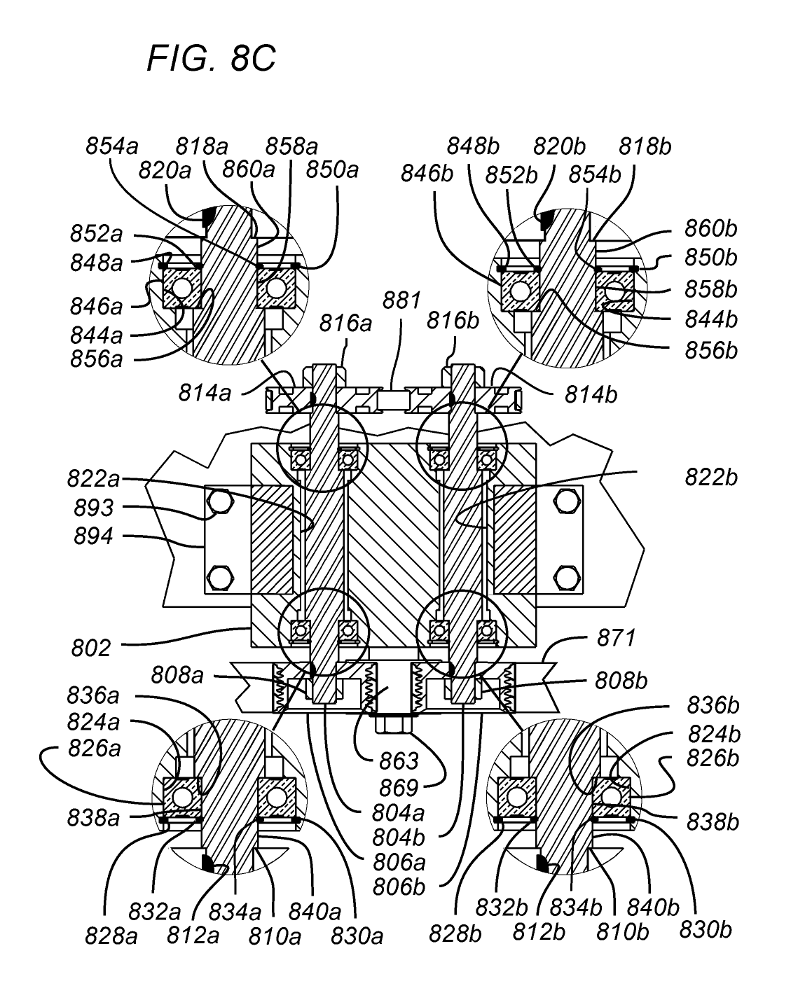

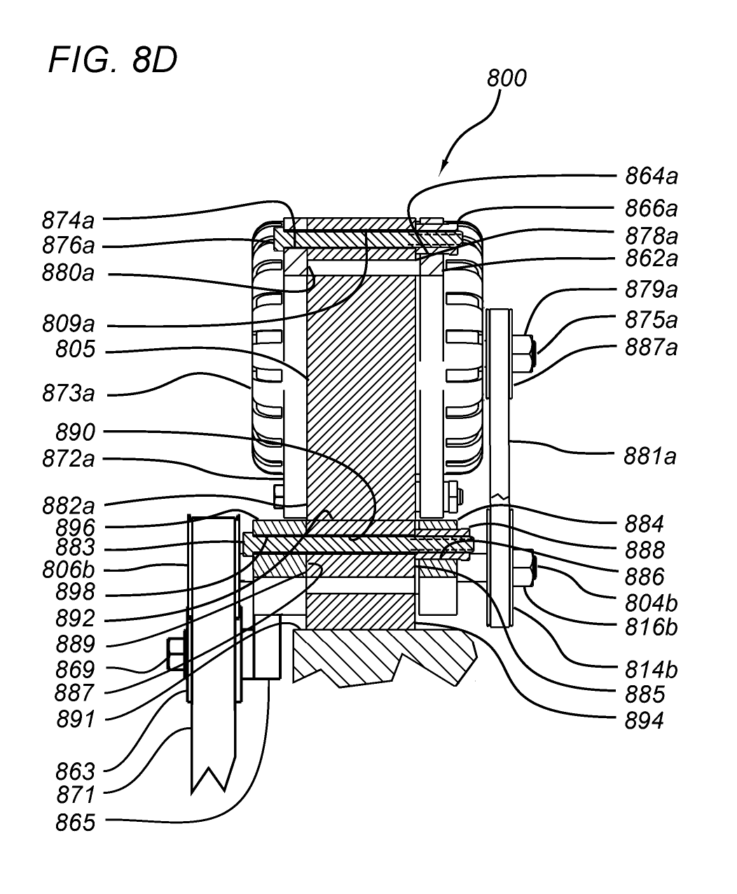

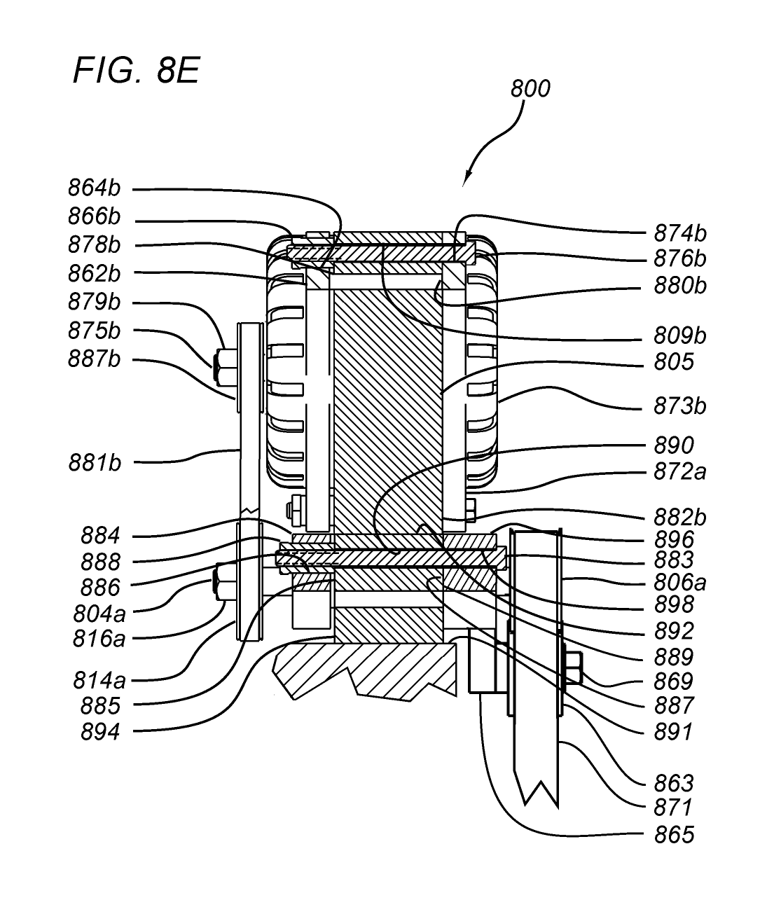

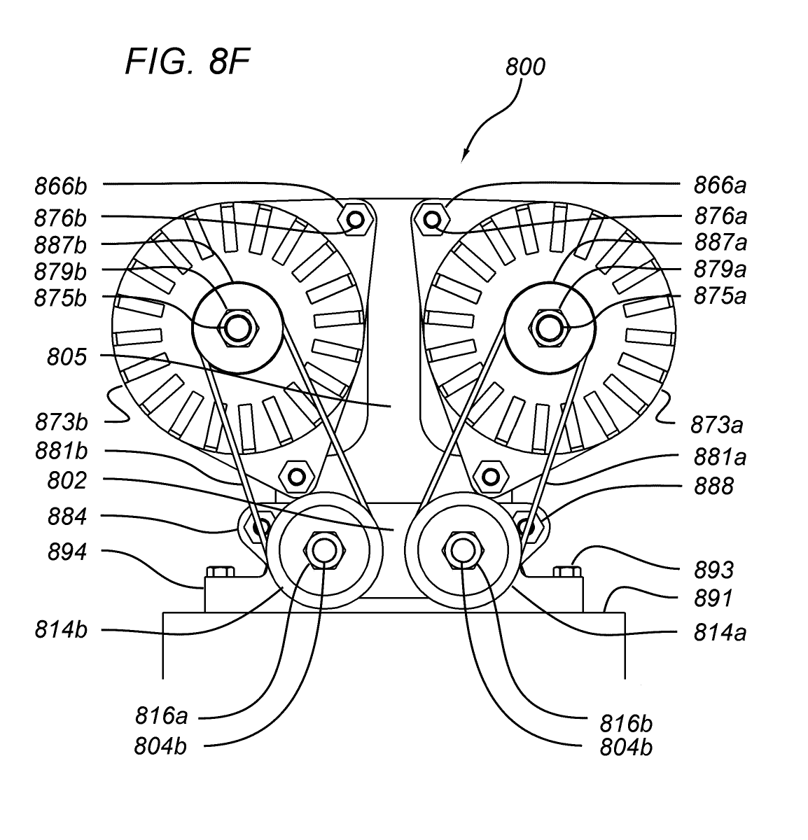

Referring now to FIGS. 8A-8F, collectively referred to as FIG. 8, a seventh embodiment of a CTC assembly 800 comprises a twin shaft CTC body 802, a first shaft 804a, and pulley 806a, which is fixed to shaft 804a by nut 808a pressing pulley 806a onto shaft surface 810a. Pulley 806a is also fixed to shaft 804a by key 812a. In certain applications the friction developed between pulley 806a and shaft surface 810a by nut 808a is sufficient to eliminate the need for key 812a. Press fitting or gluing pulley 806a onto shaft 804a can also be employed to fix pulley 806a adequately onto shaft 804a.

Pulley 814a is maintained on shaft 804a by nut 816a pressing pulley 814a onto shaft surface 818a Pulley 814a is also fixed to shaft 804a by key 820a. In certain applications the friction developed between pulley 814a and shaft surface 818a by nut 816a is sufficient to eliminate the need for key 820a. Press fitting or gluing pulley 814a onto shaft 804a can also be employed to fix pulley 806a adequately onto shaft 804a.

CTC 800 also comprises second shaft 804b, and pulley 806b which is fixed to shaft 804b by nut 808b pressing pulley 806b onto shaft surface 810b. Pulley 806b is also fixed to shaft 804b by key 812b. In certain applications the friction developed between pulley 806b and shaft surface 810b by nut 808b is sufficient to eliminate the need for key 812b. Press fitting or gluing pulley 806b onto shaft 804b can also be employed to fix pulley 806b adequately onto shaft 804b. Pulley 814b is maintained on shaft 804b by nut 816b pressing pulley 814b onto shaft surface 818b. Pulley 814b is also fixed to shaft 804b by key 820b. In certain applications the friction developed between pulley 814b and shaft surface 818b by nut 816b is sufficient to eliminate the need for key 820b. Press fitting or gluing pulley 814b onto shaft 804b can also be employed to fix pulley 806b adequately onto shaft 804b

CTC body 802 is preferably die-cast or sand-cast aluminum such A356 but other suitable casting materials such as magnesium, steel, or engineered plastic such as Polyamide-Imide. Alternatively, CTC body can be machined from a solid billet of aluminum such as 6061-T651 or other suitable material such as magnesium, steel, engineered plastic, or other appropriate material. Shafts 804a and 804b and the pulleys are preferably manufactured, respectively, from the same materials as described for CTC assembly 500.

Twin shaft body 802 contains through bore 822a. Bearing bore 824a is preferably bored to a high tolerance (e.g., +0.0001 to +0.0004 inches over nominal diameter) to accept bearing 826a and is concentric with through bore 822a. Bearing 826a is maintained in bearing bore 824a by circlip 828a seated in groove 830a. Bearing 826a is located on shaft 804a between circlip 832a seated in groove 834a and shaft surface 836a. Surface 838a on shaft 804a between groove 834a and surface 836a is preferably machined to a high tolerance (e.g., +0.0000 to −0.0003) to accept bearing 826a in assembly. Shaft surface 840a is machined with sufficient clearance to allow bearing 826a to slip past surface 840a during assembly and seat on surface 838a.

Twin shaft body 802 also contains bearing bore 844a, which is preferably bored to a high tolerance (e.g., +0.0001 to +0.0004 inches over nominal diameter) to accept bearing 846a and is concentric with through bore 822a. Bearing 846a is maintained in bearing bore 844a by circlip 848a seated in groove 850a. Bearing 846a is located on shaft 804a between circlip 852 seated in groove 854a and shaft surface 856a. Surface 858a on shaft 804a between groove 854a and surface 856a is preferably machined to a high tolerance (e.g., +0.0000 to −0.0003) to accept bearing 846a in assembly. Shaft surface 860a is machined with sufficient clearance to allow bearing 846a to slip past surface 860a during assembly and seat on surface 858a.

Through bore 822a, bearing bores 824a and 844a, and bearings 826a and 846a cooperate to align shaft 804a with through bore 822a. Bearing 826a, circlips 828a and 832a, surface 836a, bearing 846a, circlips 848a and 852a, surface 856a cooperate to fix shaft 804a in CTC-RM assembly 800. Nut 808a and surface 810a fix pulley 806a on shaft 804a. Key 812a fixes pulley 806a on shaft 804a. Nut 816a and surface 818a fix pulley 814a on shaft 804a. Key 820a also fixes pulley 814a on shaft 804a.

CTC body 802 also contains through bore 822b. Bearing bore 824b is preferably bored to a high tolerance (e.g., +0.0001 to +0.0004 inches over nominal diameter) to accept bearing 826b and is concentric with through bore 822b. Bearing 826b is maintained in bearing bore 824b by circlip 828b seated in groove 830b. Bearing 826b is located on shaft 804b between circlip 832b seated in groove 834b and shaft surface 836b. Surface 838b on shaft 804b between groove 834b and surface 836b is preferably machined to a high tolerance (e.g., +0.0000 to −0.0003) to accept bearing 826b in assembly. Shaft surface 840b is machined with sufficient clearance to allow bearing 826b to slip past surface 840b during assembly and seat on surface 838b. Bearing bore 844b is preferably bored to a high tolerance (e.g., +0.0001 to +0.0004 inches over nominal diameter) to accept bearing 846b and is concentric with through bore 822b.

CTC body 802 also contains bearing 846b, which is maintained in bearing bore 844b by circlip 848b seated in groove 850b. Bearing 846b is located on shaft 804b between circlip 852b seated in groove 854b and shaft surface 856b. Surface 858b on shaft 804b between groove 854b and surface 856b is preferably machined to a high tolerance (e.g., +0.0000 to −0.0003) to accept bearing 846b in assembly. Shaft surface 860b is machined with sufficient clearance to allow bearing 846b to slip past surface 860b during assembly and seat on surface 858b.

Through bore 822b, bearing bores 824b and 844b and bearings 826b and 846b cooperate to align shaft 804b with through bores 822b. Bearing 826b, circlips 828b and 832b, surface 836b, bearing 846b, circlips 848b and 852b, and surface 856b cooperate to fix shaft 804b in CTC assembly 800. Nut 808b and surface 810b fix pulley 806b on shaft 804b. Key 812b also fixes pulley 806b on shaft 804b. Nut 816b and surface 818b fix pulley 814b on shaft 804b. Key 820b also fixes pulley 814b on shaft 804b.

CTC body 802 also comprises stanchion 805 with left mounting ears 807a with through holes 809a and right mounting ears 807b with through holes 809b. Stanchion 805 can be an integral part of the CTC body 802 or can be fabricated separately and joined to CTC body 802 with bolts (not shown) or welded to CTC body 802. If stanchion 805 is to be fabricated separately, it is preferable it be fabricated from the same material used to fabricate CTC body 802.

In assembly, mounting ears 862a of rotating machine 873a have holes 864a that are sized to accept threaded slip bushings 866a and align with left mounting ears 807a through holes 809a of stanchion 805. Mounting ears 872a of rotating machine 873a have clearance holes 874a that accept bolts 876a and also align with left mounting ears 807a through holes 809a of stanchion 805. Bolts 876a are inserted through holes 809a and 874a and threaded into slip bushing 866a. When tightened, bolts 876a draw threaded slip bushings 866a against surface 878a of left mounting ears 807a of stanchion 805, which in turn draws surface 880a of mounting ear 872a of rotating machine 873a against surface 882a left mounting ears 807 of stanchion 805. Holes 864a, 809a, and 874a in cooperation with bolts 876a and threaded slip bushings 866a, fix rotating machine 873a to stanchion 805.

In assembly, mounting ears 862b of rotating machine 873b have holes 864b that are sized to accept threaded slip bushings 866b and align with left mounting ears 807b through holes 809b of stanchion 805. Mounting ears 872b of rotating machine 873b have clearance holes 874b that accept bolts 876b and also align with left mounting ears 807b through holes 809b of stanchion 805. Bolts 876b are inserted through holes 809b and 874b and threaded into slip bushing 866b. When tightened, bolts 876b draw threaded slip bushings 866b against surface 878b of left mounting ears 807b of stanchion 805, which in turn draws surface 880b of mounting ear 872b of rotating machine 873b against surface 882b left mounting ears 807b of stanchion 805. Holes 864b, 809b, and 874b in cooperation with bolts 876b and threaded slip bushings 866b, fix rotating machine 873b to stanchion 805.

Mounting ears 384 of CTC body 802 have holes 886 that are sized to accept slip bushings 888 and align with through holes 890 in mounting ears 892 of bracket 894. Mounting ears 896 of CTC body 802 have holes 898 that are sized to accept bolts 883 and align with through holes 890 in mounting ears 892 of bracket 894. Bolts 883 are inserted through holes 890 and 898 and threaded into slip bushings 888. When tightened, bolts 883 draw threaded slip bushings 888 against surface 885 of mounting ears 884, which in turn draws surface 887 of mounting ears 896 against surface 889 of mounting ears 892 of bracket 894. Holes 886, 890, and 898 in cooperation with bolts 883 and slip bushings 888, fix CTC body 802 to bracket 894. Bracket 894 is fixed to mounting surface 891 with bolts 893 that align with tap holes 895 in mounting surface 891.

CTC-RM assembly 800 is affixed to a power source as previously described with respect to CTC assembly 500.

Back side (smooth) idler pulley 863 is located on mounting ear 865 of CTC body 802 by bolt 869 inserted through idler pulley 863 threaded into tapped hole 867. The axis of tapped hole 867 is preferably parallel to the axis formed by shafts 804a and 804b and located below the plane formed by the axis of shafts 804a and 804b on a line midway between shafts 804a and 804b. The location of tapped hole 867 is best seen in FIG. 8B. Pulleys 863, 806a, and 806b are located to form a serpentine path for belt 871 that increases belt wrap angle and belt contact arc length over pulleys 806a and 806b. During operation belt 871 transmits power to both pulley 806a and 806b simultaneously as belt 871 travels over pulley 806a, across idler pulley 863, over pulley 806b then returning back to the engine crank pulley (not shown). Although it is advantageous to have idler pulley 863 mounted to CTC body 802, an idler pulley can be located remotely from CTC body 802 to replicate belt wrap around pulleys 806a and 806b afforded by mounting idler pulley 863 on CTC body 802.

Pulley 806a transmits power from belt 871 to rotating machine 873a through shaft 804a, pulley 814a, and belt 881a, and then to pulley 887a of rotating machine 873a. Pulley 887a being fixed to shaft 875a by nut 879a imparts rotation to shaft 875a, which in turn rotates internal components (not shown) of rotating machine 873a producing an output. Output at rotating machine 873a can be electrical power, gas compression, fluid flow or any output generated by rotating machines.

Pulley 806b transmits power from belt 871 to rotating machine 873b through shaft 804b, pulley 814b, and belt 881b, and then to pulley 887b of rotating machine 873b. Pulley 887b being fixed to shaft 875b by nut 879b imparts rotation to shaft 875b, which in turn rotates internal components (not shown) of rotating machine 873a producing an output. Output at rotating machine 873b can be electrical power, gas compression, fluid flow or any output generated by rotating machines.

Rotating machines 873a and 873b can produce different outputs and are not required to have the same functionality. For example, rotating machine 873a could be an alternator while rotating machine 873b could be an air compressor.

Belts 881a and 881b in this preferred embodiment are synchronous or ‘cogged timing’ belts. The use of synchronous belts is well known for applications where their capability to transmit large amounts of power relative to their cross sectional areas is advantageous. Although belts 881a and 881b in the preferred embodiment are synchronous belts they could instead be roller chains, v-belts, poly-v belts, ropes, or any other device suitable in transferring power from pulley 814a to pulley 887a and 814b to pulley 877b.

In automotive applications, mounting surface 891 would be the surface of the combustion engine itself. This is typically the case in automotive applications wherein the rotating machine, in this example an alternator, would use a bracket (894) to maintain alternator (rotating machine 873) to the engine. In applications where bracket 894 is relatively simple in design, CTC 800 can mount directly to the engine using tapped holes 895 thereby eliminating the need for bracket 894. However, when automobile applications have complex bracket assemblies to which many accessories are mounted, replacing the complex bracket becomes cost prohibitive. In that case, the CTC may be mounted to the existing bracket.

Although the present invention has been described in conjunction with various exemplary embodiments, the invention is not limited to the specific forms shown, and other embodiments of the present invention may be created without departing from the spirit of the invention. Variations in components, materials, values, structure, and other aspects of the design and arrangement may be made in accordance with the present invention as expressed in the following claims and legal equivalents thereof.

What is claimed is:

1. An assembly for connecting a power source to a rotating machine having at least one rotating machine pulley, the assembly comprising:
one or more first pulleys connected to the power source by one or more first belts;
one or more second pulleys connected to the rotating machine by one or more second belts; and
a shaft that transmits driving force from the one or more first pulleys to the one or more second pulleys.

2. The assembly of claim 1 wherein there is one first pulley and one second pulley.

3. The assembly of claim 1 wherein the rotating machine has a single pulley and is connected to the one or more second pulleys by the one or more second belts, and each of the second belts is a cogged belt.

4. The assembly of claim 3 wherein the rotating machine pulley has a diameter less than the diameter of each of the one or more second pulleys.

5. The assembly of any of claims 1-4 wherein each of the one or more first belts is a v-belt.

6. The assembly of claim 5 wherein there is a single v-belt.

7. The assembly of any of claims 1-6 wherein there is a single first pulley.

8. The assembly of any of claims 1-6 wherein there is a single first pulley and two idlers that increase belt contact length and torque transmittal from the power source through the assembly and to the rotating machine.

9. The assembly of any of claims 1-8 wherein each of the one or more second belts is a cogged belt.

10. An assembly for increasing the torque transmitted from a power source to a rotating machine, the rotating machine having at least one rotating machine pulley, the assembly comprising:
one or more first pulleys connected to the power source by one or more first belts;
one or more second pulleys connected to the at least one pulley of the rotating machine by one or more second belts;
wherein the one or more first pulleys has a first contact length with the one or more first belts and the rotating machine pulley has a contact length, the contact length of the one or more first pulleys being greater than the contact length of the rotating machine pulley.

11. The assembly of claim 10 that includes one first pulley and an idler on either side of the one first pulley.

12. The assembly of claim 11 wherein each idler is at least partially beneath or partially above the one first pulley.

13. The assembly of claim 11 wherein each of the one or more first belts is a v-belt.

14. The assembly of claim 13 that includes one first belt.

15. An assembly for increasing the speed of a rotating machine having at least one rotating machine pulley and powered by a power source without increasing the speed of the power source, the assembly comprising:
one or more first pulleys connected to the power source by one or more first belts;
one or more second pulleys connected to the rotating machine pulley by one or more second belts;
wherein the diameter of each of the one or more second pulleys is greater than the diameter of the rotating machine pulley.

16. The assembly of claim 15 that includes one second pulley.

17. The assembly of claim 16 wherein the one second pulley is offset from a vertical axis passing through the rotating machine pulley.

18. The assembly of claim 15 wherein each of the second belts is a cogged belt.

19. The assembly of claim 16 wherein the second pulley has a diameter of 25% or more than the diameter of the rotating machine pulley.

20. A torque conversion machine device comprising:
the assembly of any of claims 1-19;
a rotating machine connected to the assembly;
a casing at least partially surrounding the assembly and the rotating machine; and
a mount for mounting the machine in proximity to a power source that transmits power to the rotating machine through the assembly.

21. The machine of claim 20 wherein each first pulley is exterior to the casing.

22. A method for generating more speed from a rotating machine having at least one rotating machine pulley from a power source without increasing the speed of the power source, the method comprising:
disconnecting the rotating machine from the power source;
removing the rotating machine pulley and replacing it with a smaller-diameter rotating machine pulley;
connecting one of the assemblies of claims 1-19 to the power source by one or more first belts connected to the one or more first pulleys; and
connecting the rotating machine to the assembly by one or more second belts connected to the one ore more second pulleys and to the smaller-diameter rotating machine pulley.

23. The method of claim 22 wherein the rotating machine is removed by disconnecting it from a mount and the assembly is attached to the same mount without modifications to the mount.

24. The method of claim 23 that is one or more brackets and/or one or more surfaces.

25. The method of claim 22 wherein the assembly has a receptacle for at least partially receiving the rotating machine.

26. The method of claim 22 wherein the torque transmitted to the rotating machine by the power source is increased.

27. A method for generating more speed from a rotating machine having a rotating machine pulley from a power source without increasing the speed of the power source, the method comprising:
disconnecting the rotating machine from the power source;
connecting one of the assemblies of claims 1-19 to the power source by one or more first belts connected to the one or more first pulleys; and
connecting the rotating machine to the assembly by one or more second belts connected to the one ore more second pulleys and to the smaller-diameter pulley.

28. The assembly of any of claims 1-19 wherein the power source is one of the group consisting of: a diesel engine, a gasoline engine, an electric motor, a pneumatic motor, a hydro turbine, a wind turbine, and a hydraulic motor.

29. The assembly of claims 1-19 wherein the rotating machine is an alternator.

30. The assembly of claims 1-19 wherein the rotating machine is a generator.

31. The assembly of claims 1-19 wherein the rotating machine is a pump.

32. The assembly of claims 1-19 wherein the rotating machine is a compressor.
